(19) United States
(12) Patent Application Publication
(10) Pub. No.: US 2011/0282059 A1
(43) Pub. Date: Nov. 17, 2011

(54) Light emitting material for use as host dopant in emissive layer for OLEDs

(75) Inventors: Etienne David Baranoff, Renens VD (CH); IL Jung, Ecublens (CH); Mohammad Khaja Nazeeruddin, Ecublens (CH); Michael Graetzel, Saint Sulpice (CH)

(73) Assignee: SOLVAY SA, Brussels (BE)

(21) Appl. No.: 13/146,509

(22) PCT Filed: Feb. 8, 2010
(86) PCT No.: PCT/EP10/51508

§ 371 Date: Jul. 27, 2011

(30) Foreign Application Priority Data
Feb. 6, 2009 (KR) PCT/KR2009/000590

(51) Int. Cl. C07F 15/00

(52) U.S. Cl. 546/5; 546/10; 546/2

(57) ABSTRACT

A light emitting material comprising a complex of formula (I): (L¹)ₓ-M-(L²)_{y} wherein L¹ is a mono-anionic bidentate carbon-coordinating ligand comprising the structural element (II) in a ring system, wherein R1 is a substituent selected from the group consisting of R₁-1 to R₁-8, the use thereof as emissive materials in organic light emitting devices, and organic light emitting devices comprising said emissive material.

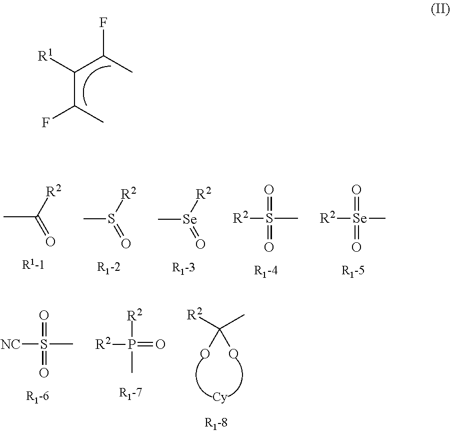

This invention relates to a light-emitting material, to the use of said material and to a light-emitting device capable of converting electric energy to light.

Organic light emitting devices (OLEDs) have found increasing interest in the recent past for their potential role in the development of new display systems for a variety of applications.

OLEDs are based on electroluminescence (EL) from organic materials.

In contrast to photoluminescence, i.e. the light emission from an active material as a consequence of optical absorption and relaxation by radiative decay of an excited state, electroluminescence is a non-thermal generation of light resulting from the application of an electric field to a substrate. In this latter case, excitation is accomplished by recombination of charge carriers of contrary signs (electrons and holes) injected into an organic semiconductor in the presence of an external circuit.

A simple prototype of an organic light-emitting diode (OLED), i.e. a single layer OLED, is typically composed of a thin film of the active organic material which is sandwiched between two electrodes, one of which needs to be semitransparent in order to observe light emission from the organic layer, usually an indium tin oxide (ITO)-coated glass substrate used as anode.

If an external voltage is applied to the two electrodes, charge carriers, i.e. holes at the anode and electrons at the cathode, are injected to the organic layer beyond a specific threshold voltage depending on the organic material applied. In the presence of an electric field, charge carriers move through the active layer and are non-radiatively discharged when they reach the oppositely charged electrode. However, if a hole and an electron encounter one another while drifting through the organic layer, excited singlet (anti-symmetric) and triplet (symmetric) states, so-called excitons, are formed. Light is thus generated in the organic material from the decay of molecular excited states (or excitons). For every three triplet excitons that are formed by electrical excitation in an OLED, only one anti-symmetric state (singlet) exciton is created.

Many organic materials exhibit fluorescence (i.e. luminescence from a symmetry-allowed process) from singlet excitons; since this process occurs between states of like symmetry it may be very efficient. On the contrary, if the symmetry of an exciton is different from that of the ground state, then the radiative relaxation of the exciton is disallowed and luminescence will be slow and inefficient. Because the ground state is usually anti-symmetric, decay from a triplet breaks symmetry; the process is thus disallowed and efficiency of EL is very low. Thus the energy contained in the triplet states is mostly wasted and the maximum achievable theoretical quantum efficiency is only 25% (where quantum efficiency refers to the efficiency with which holes and electrons recombine to produce luminescence).

Luminescence from a symmetry-disallowed process is known as phosphorescence. Characteristically, phosphorescence may persist for up to several seconds after excitation due to the low probability of the transition, in contrast to fluorescence, which decays rapidely due to the high probability of the transition.

Successful utilization of phosphorescent materials holds enormous promises for organic electroluminescent devices. For example, an advantage of utilizing phosphorescent materials is that all excitons (formed by combination of holes and electrons in an EL), which are (in part) triplet-based in phosphorescent devices, may participate in energy transfer and luminescence. This can be achieved either via phosphorescence emission itself, or using phosphorescent materials for improving efficiency of the fluorescence process as a phosphorescent host or a dopant in a fluorescent guest, with phosphorescence from a triplet state of the host enabling energy transfer from a triplet state of the host to a singlet state of the guest.

Due to spin-orbit coupling that leads to singlet-triplet mixing a number of heavy metal complexes display efficient phosphorescence from triplets at room temperature and OLEDs comprising such complexes have been shown to have internal quantum yields of more than 75%.

In particular certain organometallic iridium complexes exhibit intense phosphorescence and efficient OLEDs emitting in the red and green spectrum have been prepared with these complexes. As a means for improving the properties of light-emitting devices, there has been reported a green light-emitting device utilizing the emission from the ortho-metalated iridium complex Ir(PPy)3 (tris-ortho-metalated complex of iridium (III) with 2-phenylpyridine), see e.g. Appl. phys. lett. 1999, vol. 75, p. 4.

In any case, it is important that the light emitting material provides electroluminescence emission in a relatively narrow band centered near selected spectral regions, which correspond to one of the three primary colors, red, green and blue, so that they may be used as a colored layer in an OLED.

U.S. Pat. No. 6,858,327 which corresponds to US patent application US2004/091738 discloses organic light emitting materials comprising bis-ortho-metalated complexes of Iridium (III) with 2-phenylpyridine (ppy)-ligands and devices comprising said materials.

The complexes have the general structure

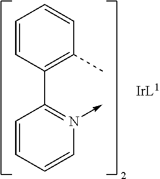

wherein L¹ is an ancillary ligand which can have a variety of structures.

The phenyl ring of the ppy-ligand can be substituted in o- and p-position to the carbon atom bonded to the pyridine ring and in particular a 2,4-difluoro substitution is disclosed in compound 2 of the reference, compounds 3 and 4 of the reference showing respective complexes having an additional substituent at the pyridine ring.

U.S. Pat. No. 7,037,598 discloses novel bis-ortho-metallated iridium ppy-complexes wherein a variety of various substituents can be used for R¹ to R⁸ in the subsequent general formula

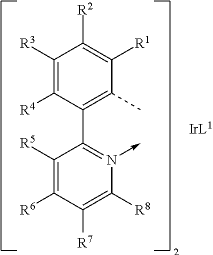

and L¹ can also have a variety of meanings. Amongst the specific examples given on the ppy-ligand are 2-(4-fluorophenyl)-pyridine, 2-(2,4-difluorophenyl)-pyridine and 2-(2,3,4-trifluorophenyl)-pyridine as well as 2-(2,4-difluorophenyl)-4-dimethylamino-pyridine. No substituents other than fluorine are disclosed for the 3-position of the phenyl ring.

US 2004/0121184 discloses in formula 7 in column 9 a bis-ortho-metalated Ir(ppy) complex, wherein the phenyl ring of the ppy-ligand bears two fluorine substituents in 2 and 4 position and a cyano group in 3-position, with the pyridine ring also potentially substituted.

US 2004/0188673 discloses electroluminescent iridium compounds with fluorinated phenylpyridines, phenylpyrimidines and phenylquinolines. The reference is generally directed to iridium complexes having at least two phenylpyridine ligands in which there is at least one fluorine or fluorinated group on the ligand. Whereas the fluorine containing substituent can take any position in the pyridine or phenyl ring, preferred examples given are ppy-ligands substituted in either the 4-position of the phenyl ring or the 4-position of the pyridine ring. Preferred fluorine containing substituents are fluorine, perfluorinated alkyl or perfluorinated alkoxy.

Int. J. Mol. Sci. 2008, 9, 1527 pp. discloses information on the working principle of iridium based emitter materials in phosphorescent organic light emitting devices and gives information on the emissive properties of such complexes as a function of the structure of the ligand. It is said that changing the nature of the cyclometalating ligand can be used for colour tuning.

WO 2002/15645 discloses phosphorescent Ir complexes with phenylpyridine ligands disubstituted with fluorine atoms in the phenyl ring with a variety of ancillary ligands and the influence of the structure of the ancillary ligand on the emission wavelength.

Whereas emitting materials showing EL emission in the green and red range have been developed which show an acceptable combination of luminescence yield and stability, improvement is still needed as to light emitting materials emitting in the blue range.

It is thus an object of the instant invention to provide light emitting materials showing a good stability and a satisfactory EL luminescence. It is a further object of the invention to provide light emitting materials with an emission maximum in the blue range of the spectrum, in particular at wavelengths of from 440 to 500 nm.

These objects are achieved with the light emitting materials in accordance with claim 1. Preferred embodiments are set forth in the sub-claims and in the following detailed specification.

Further objects of the invention are emitting layers comprising said light emitting materials and organic light emitting devices comprising said light emitting material.

The light emitting materials in accordance with the instant invention have the following general formula I

(L¹)ₓ-M-(L²)_{y} (I)

wherein L¹ is a mono-anionic bidentate carbon-coordinating ligand comprising the structural element

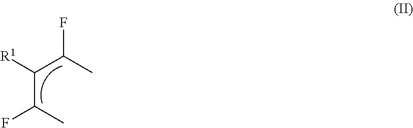

in a ring system, wherein R1 is a substituent selected from the group consisting of R₁-1 to R₁-8

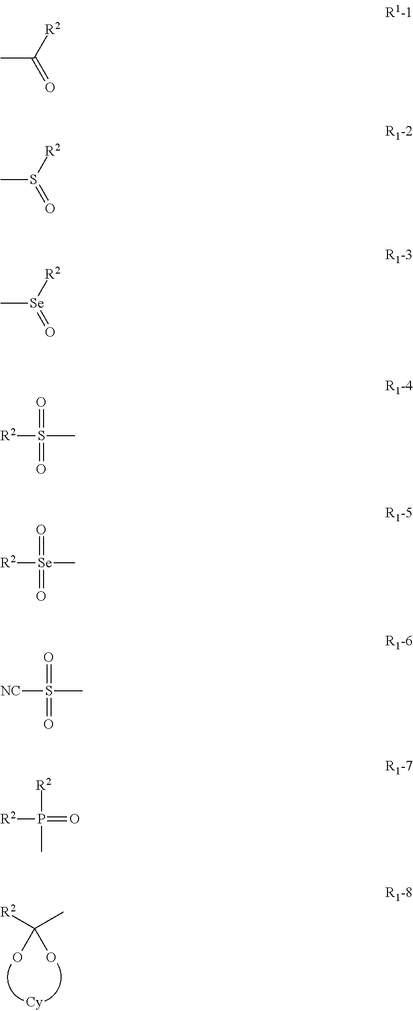

where R² represents a substituted linear, branched or cyclic alkyl chain having 1-20 carbon atoms or an optionally substituted alkoxy group with 1 to 20 carbon atoms, and
Cy represents a 4 to 7 membered carbocyclic or heterocyclic ring, which may be partially or fully substituted by substituents selected from the group consisting of optionally substituted linear, branched or cyclic alkyl or alkoxy chains with 1 to 20 carbon atoms.

R² represents preferably a partially or fully fluorinated alkyl group having 1-20, preferably 1 to 8 carbon atoms and particularly preferred 1 to 4 carbon atoms. Especially preferred substituents R² are trifluoromethyl, hexafluoroethyl and the isomers of fluorinated propanes.

A preferred group of substituents R₁-8 are cyclic acetals having the general formula

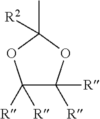

wherein each R″ can be the same or different and can individually and independently from the other substituents have the same meaning as R² and in addition may represent the respective unsubstituted radicals R².

L² in formula I is a non-mono anionic, non-bidentate or non-carbon coordinating ligand.

M in formula I represents a transition metal with an atomic number of at least 40, preferably of groups 8 to 12 of the periodic system. Preferred transition metals are Re, Os, Ir, Pt, Au, Ru, Rh, Pd and Cu of which Ir and Pt are particularly preferred.

x in formula I is an integer of from 1 to 3 and y is zero, 1 or 2.

L¹ is designated as a carbon-coordinating ligand because the metal is bound to the ligand through a carbon-metal bond and it is designated as mono-anionic because only one carbon atom of the ligand is bound to the metal.

L¹ is a bidentate ligand, i.e. it has two points of attachment to the metal atom.

Preferred light emitting materials are described in more detail hereinafter and also in the dependent claims.

Preferred ligands L¹ have the following general formula III

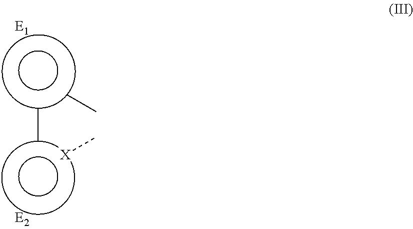

wherein:
E₁ represents a nonmetallic atoms group required to form a 5- or 6-membered carbocyclic or heterocyclic, preferably aromatic or heteroaromatic ring, optionally condensed with additional aromatic moieties or non-aromatic cycles, said ring optionally having one or more substituents, optionally forming a condensed structure with the ring comprising E₂, said ring E₁ coordinating to the metal M via a sp² hybridized carbon and said ring E₁ comprising the structural element (II) as defined above;
E₂ represents a nonmetallic atoms group required to form a 5- or 6-membered heterocyclic, preferably heteroaromatic ring, optionally condensed with additional aromatic moieties or non aromatic cycles, said ring optionally having one or more substituents, optionally forming a condensed structure with the ring comprising E₁, said ring E₂ coordinating to the metal M via a sp² hybridized nitrogen, and
X represents a coordinating atom selected from groups IVa, Va or VIa of the periodic system.

Preferred coordinating atoms X are C, N, O, S, Se, Te and P, of which C and N are particularly preferred.

E₁ in Formula III preferably represents a 5-10, preferably a 5-6-membered aromatic or heteroaromatic ring, i.e. an aryl or heteroaryl group. As used herein an aryl group is typically a C₆-C₁₀ aryl group such as phenyl or naphthyl, which may be substituted by one or more substituents. Reference to an aryl group also includes fused ring groups in which an aryl group as defined before is fused to a carbocyclyl, heterocyclyl or heteroaryl group, which themselves may be fused to further ring systems or bearing one or more substituents.

The ring E₁ comprises the structural element of formula II, i.e. a difluoro-substituted element having two fluorine substituents each bound to a carbon atom, said fluorine substituted carbon atoms separated by a carbon atom bearing a substituent R¹ as defined hereinbefore.

According to a preferred embodiment, E₁ is a 2,4-difluorosubstituted phenyl ring of formula V

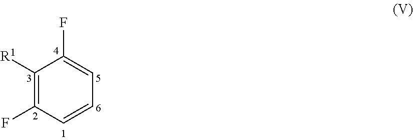

wherein the said phenyl ring is bound to the transition metal atom and to E₂ through vicinal carbon atoms.

According to a further preferred embodiment, E₂ represents a five or six membered aromatic or heteroaromatic ring, of which 5- and 6-membered heteroaromatic rings, in particular pyridine are preferred. In a specific embodiment, E₂ represents a pyridine ring attached to E₁ via carbon atom 2 of the pyridine ring.

Exemplary ligands L¹ comprising the structural element II are the following:

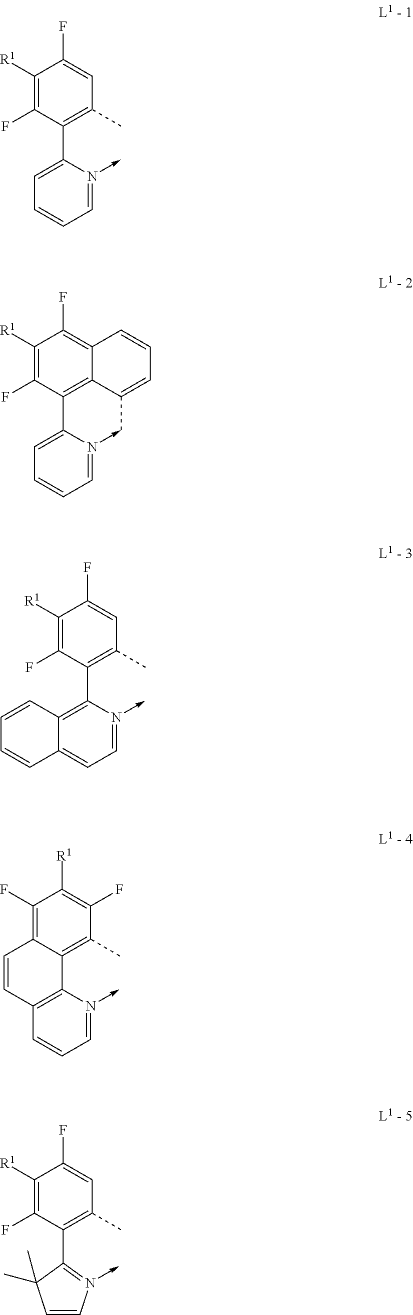

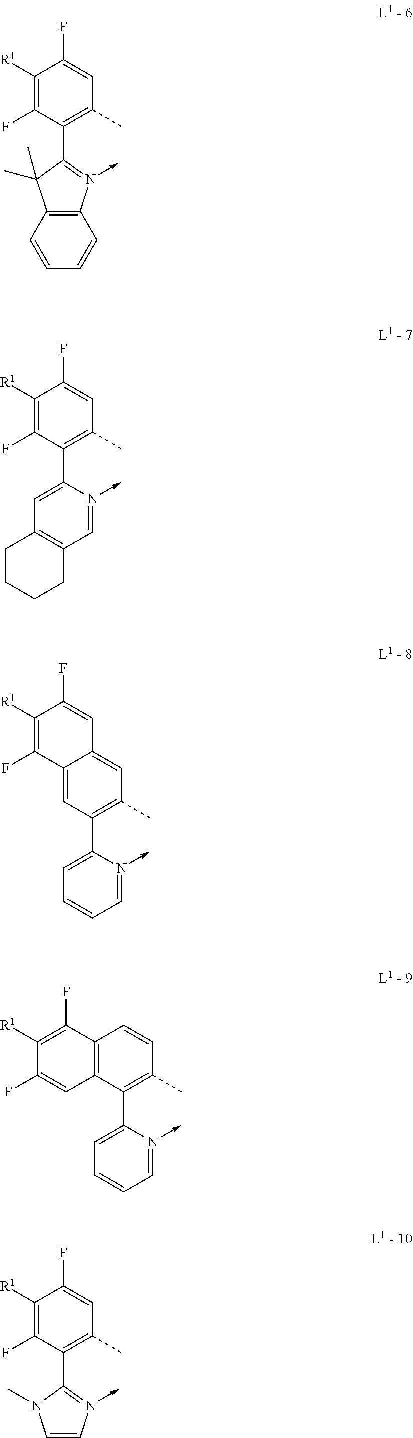

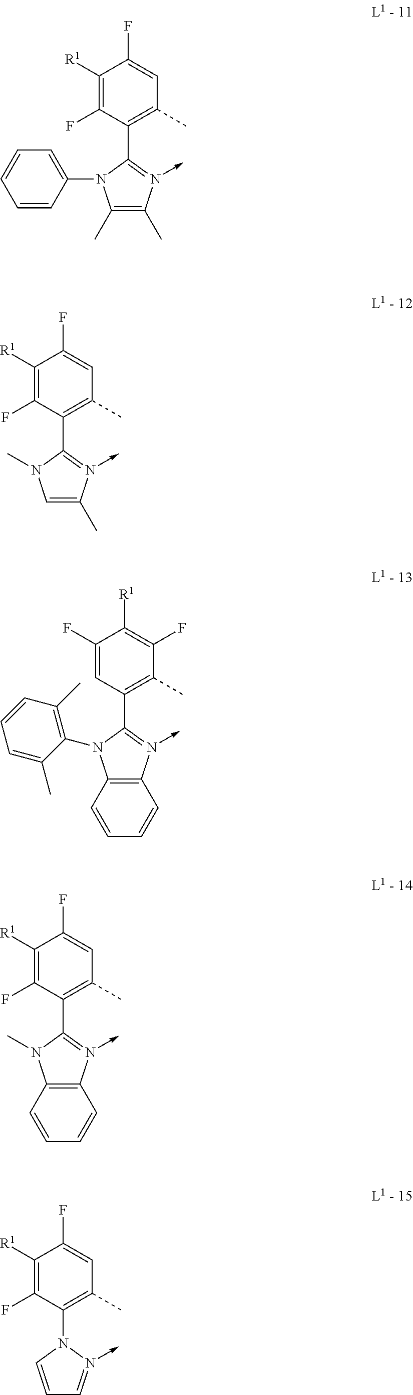

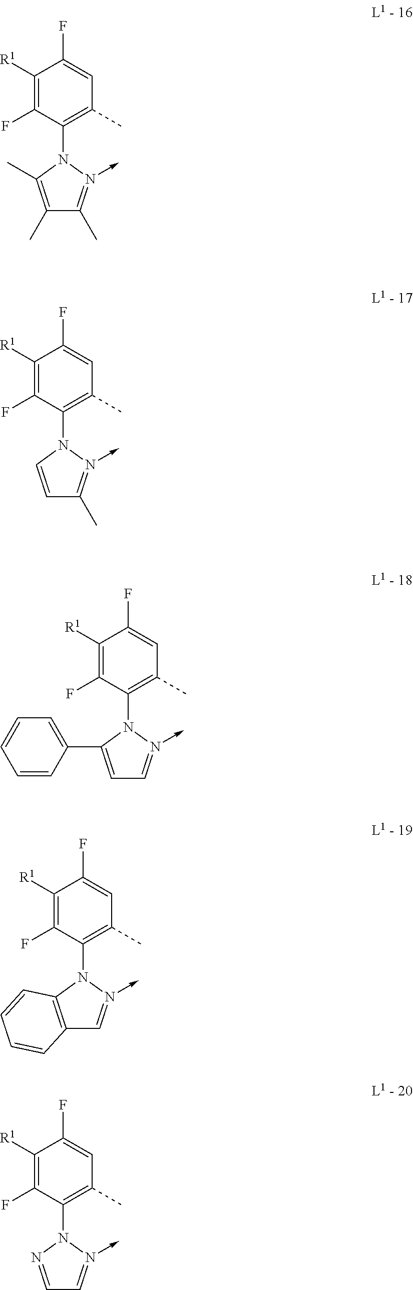

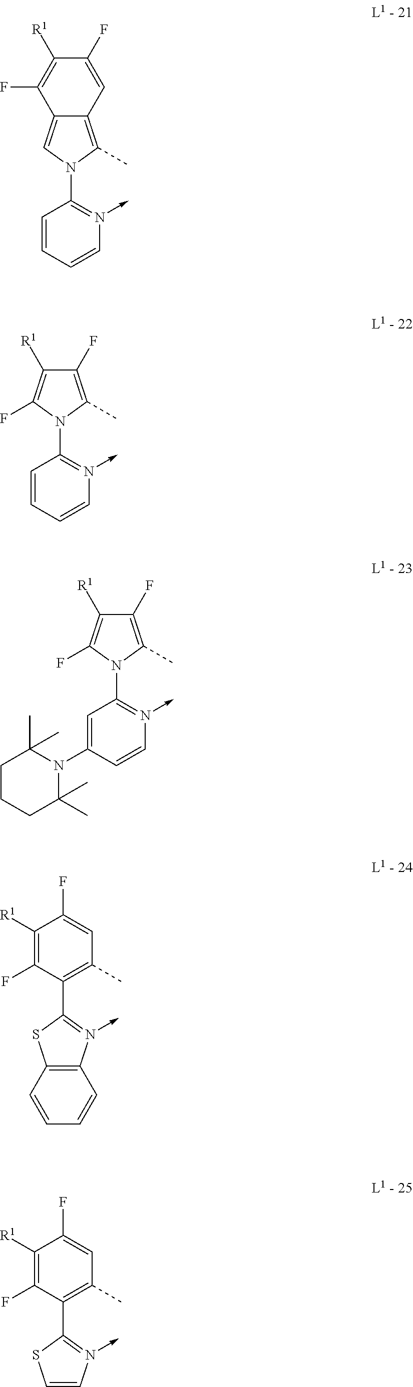

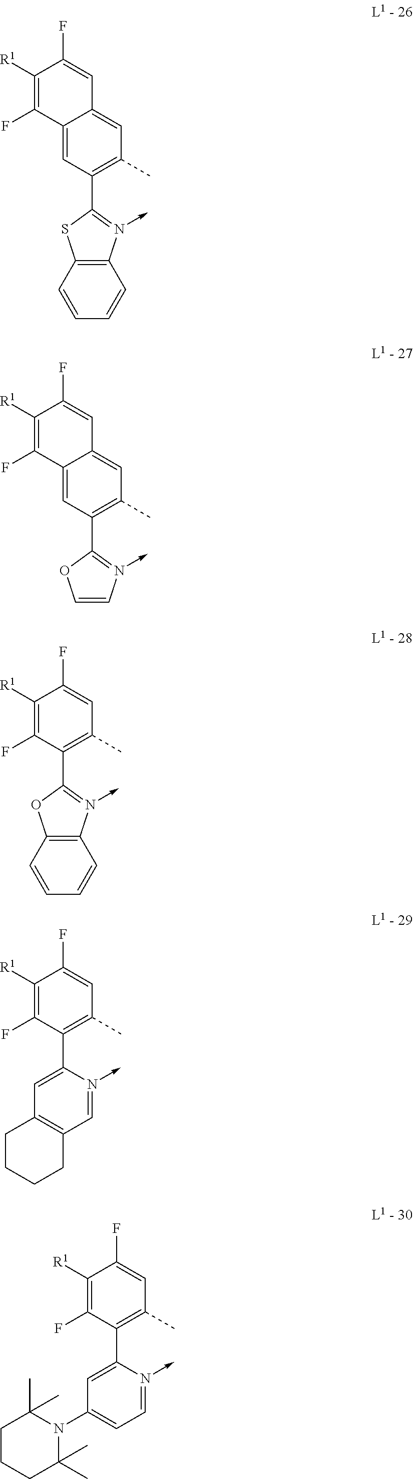

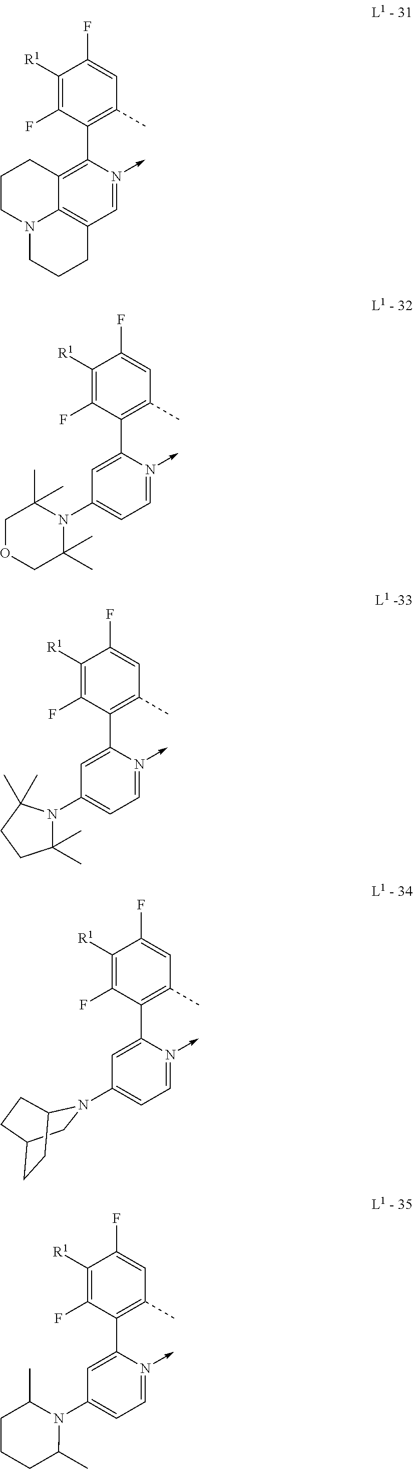

of which L¹-1 and L¹-29 to L¹-35 are preferred.

As mentioned above, the ring E₂ of ligand L¹ can carry one or more acyclic substituents, preferably selected from the group consisting of strong electron donor groups, i.e. groups having a negative Hammett substituent constant. Examples of preferred substituents at the ring E₂ are C₁-C₈-alkyl, C₁-C₈-thioalkyl, C₁-C₈-alkoxy, amino, C₁-C₈-alkylamino, C₁-C₈-dialkylamino and disubstituted amino groups with sterically rigid structures as e.g. cyclic acetal structures.

Particular preferred dialkylamino substituents are amino groups with sterically rigid structures, dimethylamino and diethylamino, preferably in para-position to the atom connecting E₂ with E₁, i.e. in the case of a pyridine ring as E₂ in 4-position of the pyridine ring. By way of example, the substituted amino groups on the pyridine ring depicted in L¹-30 to L¹-35 are mentioned as preferred sterically rigid structures.

A particularly preferred ligand L¹ is optionally substituted 2-phenylpyridine (ppy) represented by formula L¹-1 above and phenylpyridine compounds depicted by structures L¹-29 to L¹-31 and L¹-33.

L2 is a “non-mono anionic”, “non-bidentate” or “non-carbon coordinating” ligand, i.e. a ligand either bonding to the metal through more than one anionic atom (non-mono anionic), or only forming one bond with the metal (non-bidentate) or coordinating to the metal atom through atoms other than carbon (non carbon-coordinating). L² is commonly referred to as ancillary ligand. Exemplary ancillary ligands are e.g. described in WO 02/015645.

According to a first preferred embodiment, the ligand L² is a mono-anionic non-C coordinating, bidentate ligand selected from the structures represented by following formulae L²-1 to L²-7 or tautomers thereof:

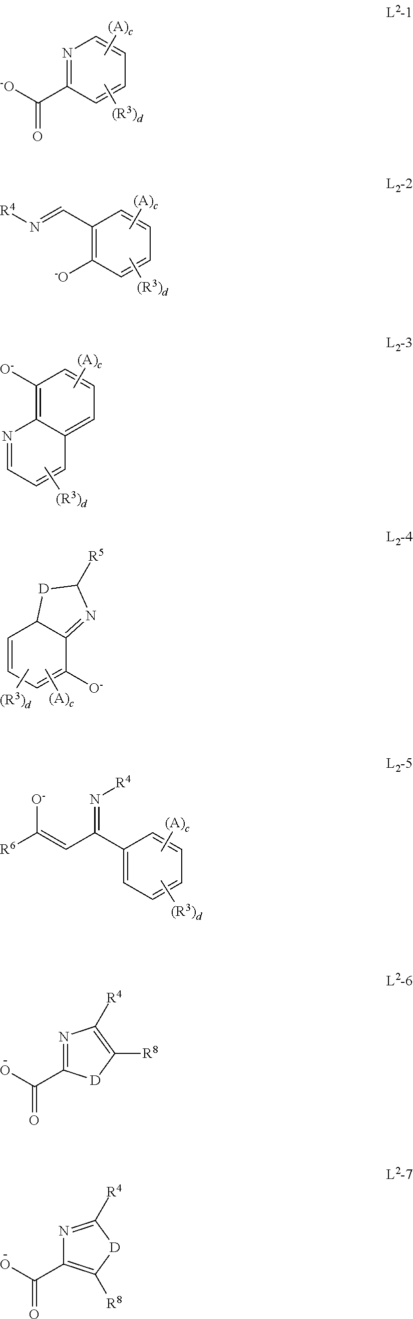

wherein:
A is a substituent selected from the group consisting of halogens, such as —Cl, —F, —Br; —OR₇; —SR₇; —N(R₇)₂; —P(OR₇)₂ and —P(R₇)₂; wherein R₇ is a C₁-C₆ alkyl, fluoro- or perfluoroalkyl group, e.g. —CH₃, —nC₄H₉, —iC₃H₇, —CF₃, —C₂F₅, —C₃F₇ or a C₁-C₆ alkyl, fluoro- or perfluoroalkyl having one or more ether groups, e.g. —CH₂₋(CH₂₋O—CH₂)ₙ—CH₃, —CH₂—[CH₂(CH₃)—O—CH₂]ₙ—CH₃, —(CF₂O) ₙ—C₂F₅, with n being an integer from 1 to 8; preferably A is chosen among —OR₇ and —N(R₇)₂, wherein R₇ has the above meaning.
D is a group chosen among the group consisting of —CHR⁸—, —CR⁸R⁸—, —CR⁸═CH—, —CR⁸═CR⁸—, N—H, N—R⁹, O, S or Se;
R³, R⁵, R⁶ are the same or different from each other and at each occurrence, represent F, Cl, Br, NO₂, CN, a straight-chain or branched or cyclic alkyl or alkoxy group having from 1 to 20 carbon atoms, in each of which one or more nonadjacent —CH₂— groups may be replaced by —O—, —S—, —NR⁹—, or —CONR¹⁰—, and in each of which one or more hydrogen atoms may be replaced by F; or an aryl or heteroaryl group having from 4 to 14 carbon atoms which may be substituted by one or more nonaromatic radicals —R′; and a plurality of substituents R′, either on the same ring or on the two different rings, may in turn together form a further mono- or polycyclic ring system, optionally aromatic;
R⁴, R⁸, R⁹ and R¹⁰ are the same or different from each other and at each occurrence and are each H or an aliphatic or aromatic hydrocarbon radical, optionally substituted, having from 1 to 20 carbon atoms;
c is an integer from 1 to 3;
d is an integer from 0 to 4.

According to a second preferred embodiment, L² comprises two monodentate ligands which may be the same or different. One of these monodentate ligands (hereinafter designated as T) is preferably chosen among cyanide (CN), thiocyanate (NCS) and cyanate (NCO); preferably cyanide (CN); and the second monodentate ligand (hereinafter designated as U) is a monodentate neutral ligand, coordinating to the metal M through a sp² or sp³ hybridized nitrogen atom, preferably through a sp² hybridized nitrogen atom. The emitting materials in accordance with this embodiment may be characterized by the general formula

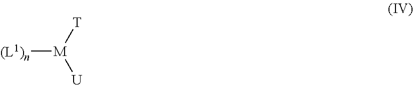

Non limitative examples of monodentate neutral ligands U coordinating to the metal through a sp³ hybridized nitrogen atom are notably those encompassed by the following formula:

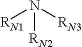

wherein R_{N1}, R_{N2}, R_{N3}, equal or different each other, are independently chosen among C₁₋₂₀ hydrocarbon group, e.g. aliphatic and/or aromatic, linear or branched, optionally substituted.

Preferred monodentate neutral ligands U coordinating to the metal through a sp^{a} hybridized nitrogen atom are those complying with formula here below:

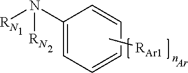

wherein R_{N1}, R_{N2} have the same meaning as above defined, preferably R_{N1}, R_{N2} being independently chosen among C₁₋₂₀ aliphatic group, linear or branched, optionally substituted,
R_{Ar1} is a substitutent optionally comprising heteroatoms, e.g. nitrogen or oxygen, like notably a C₁₋₆ alkoxy group, a C₁₋₆ dialkyl amino group and the like; preferably R_{Ar1} being a methoxy group;
n_{Ar}, being an integer from 0 to 5, preferably from 1 to 3, more preferably 2.

Preferably the monodentate neutral ligand U coordinates to the metal through a sp² hybridized nitrogen atom. Monodentate neutral ligands L² coordinating to the metal through a sp² hybridized nitrogen atom comprise advantageously at least one imine group.

Particularly preferred monodentate neutral ligands U are selected from the following structures U-1 to U-8 or tautomers thereof

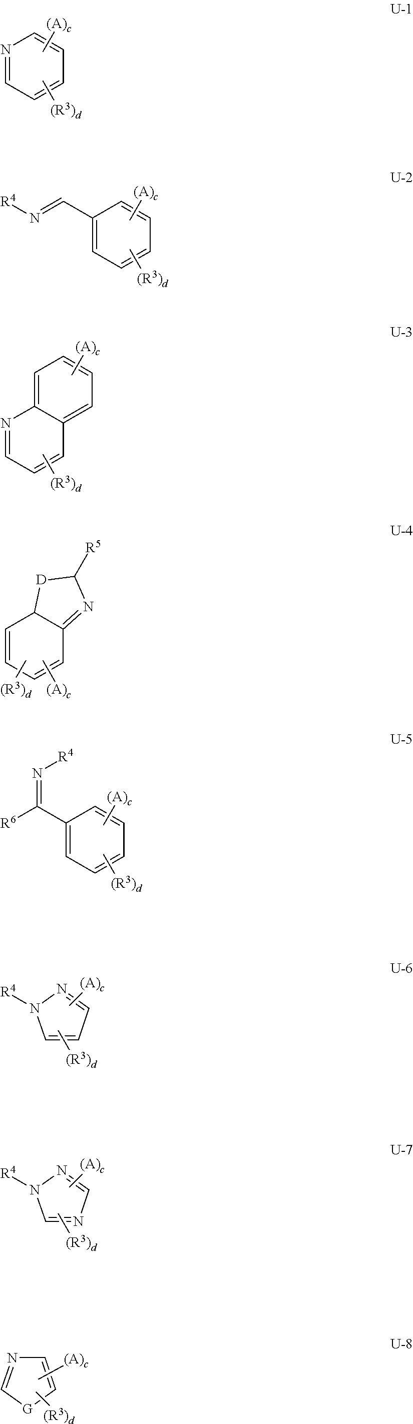

wherein A, D and R³ to R¹⁰ have the meaning as defined hereinbefore with regard to ligands L²-1 to L²-5;
G is a group chosen among the group consisting of —CH═CH—, —CR⁸═CH—, —CR⁸═CR⁸—, N—H, N—R⁹ and CR⁸═N—;
c is an integer of from 0 to 3 and
d is an integer of from 0 to 3.

As used herein, the term tautomer is intended to denote one of two or more structural isomers that exist in equilibrium and are readily converted from one isomeric form to another, by, for instance, simultaneous shift of electrons and/or of a hydrogen atom.

According to a further preferred embodiment, ligand L² is a bidentate phosphinocarboxylate monoanionic ligand bound to the metal through an oxygen and a phosphorous atom represented by the general formula PL

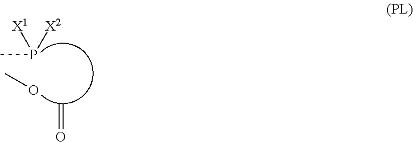

wherein X¹ and X² are the same or different and are selected from C₁-C₈-alkyl, aryl, heteroaryl, which may optionally be substituted by one or more substituents.

The chelate bidentale phosphinocarboxylate monoionic ligand PL in this embodiment generally forms with the central transition metal atom, a 5-membered, 6-membered or 7-membered metalacycle, that is to say that the phosphino group and the carboxylate moiety can be separed notably by one, two or three carbon atoms.

Particularly preferred ligands PL are those wherein the phosphino group and the carboxylate group are bound to the same carbon atom; these ligands advantageously form complexes comprising a 5-membered metalacycle, which is in most cases particularly stable.

According to a fourth preferred embodiment, the ligand L² is chosen from the following preferred ligands L²-8 to L²-27 as disclosed in WO 02/15645:

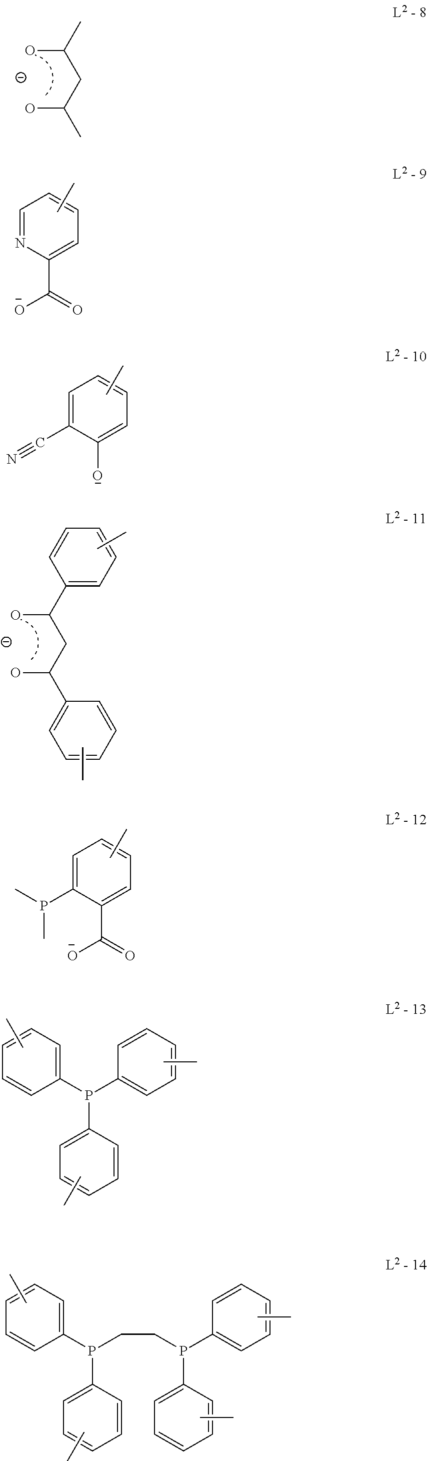

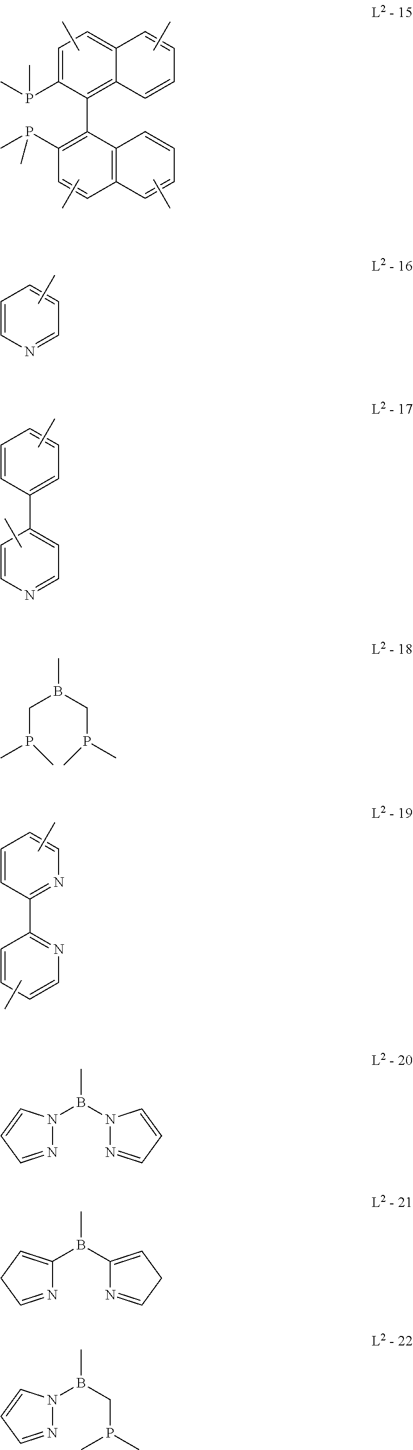

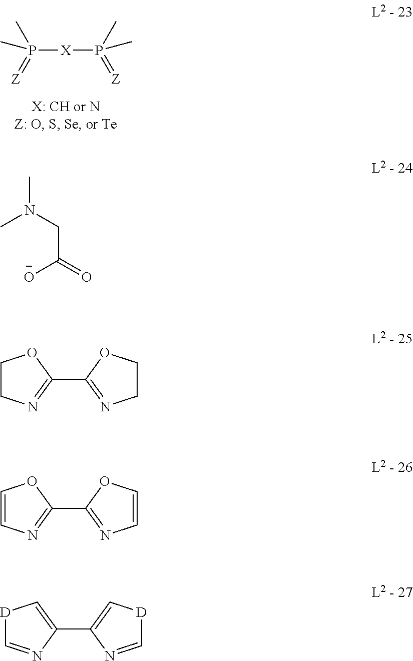

In the foregoing structures any substituent depicted by a bond symbol may be independently selected from hydrogen, halogen, C₁-C₈— alkyl or an aryl group.

The foregoing description has outlined the possibilities for the structure of the various elements of the emitter materials in accordance with the instant invention. In this regard, any of the preferred ligands L¹ can be combined with any of the preferred ligands L² (including ligands T, U and PL) and any of these possible combinations is contemplated within the scope of the instant invention. For the skilled artisan it is obvious how any ligand L1 as contemplated by formula I, in particular any of preferred ligands L¹-1 to L¹-35 can be preferably combined with any of ligands L² as contemplated in formula I, in particular with any preferred ligands L²-1 to L²-5, T, U and PL and the foregoing preferred ligands in accordance with WO 02/15645.

Particularly preferred emitter materials are those of general formula III with E¹ and E² having the meaning as defined hereinbefore and wherein L² is selected from L²-1 to L²-27, T, U₁ to U₈ or PL.

Most preferred are emitter materials wherein L¹ represents a substituted 2-phenylpyridine moiety comprising the structural element II and optionally one or more substituents, preferably substituents with a negative Hammett substituent constant, i.e. strong donor groups, in the pyridine ring. The following compounds represent particularly preferred emitter materials in accordance with the instant invention

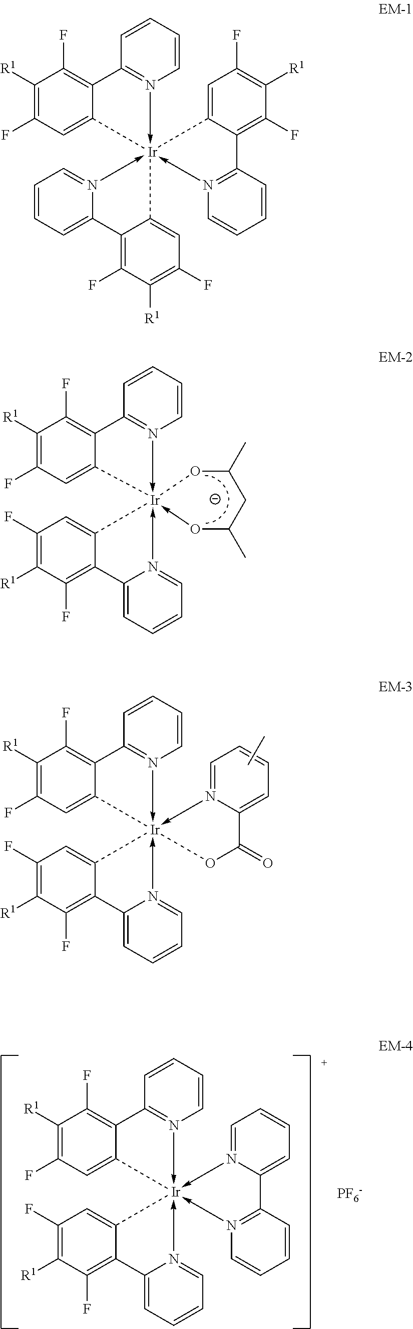

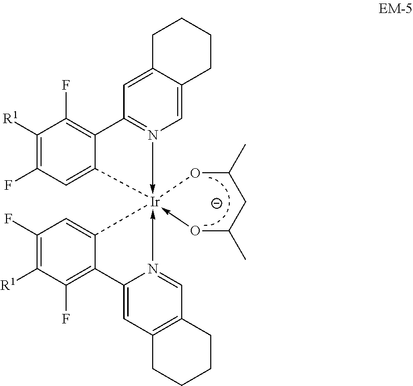

Particularly preferred emitter materials are Ir complexes with an optionally substituted 2-phenylpyridine moiety as ligand L¹ and comprising an optionally substituted picolinate or acetylacetone moiety as ligand L². Those complexes have shown a good chemical and thermal (as for sublimation) stability which can be advantageous in the processing of the materials.

The synthesis of complexes of formula (I) here above, i.e. metal complexes comprising two orthometalated ligands (ĈN ligands) and an ancillary ligand (L), as above specified, can be accomplished by any known method. Details of synthetic methods suitable for the preparation of complexes of formula (I) here above are notably disclosed in “Inorg. Chem.”, No. 30, pag. 1685 (1991); “Inorg. Chem.”, No. 27, pag. 3464 (1988); “Inorg. Chem.”, No. 33, pag. 545 (1994); “Inorg. Chem. Acta”, No. 181, pag. 245 (1991), “J. Organomet. Chem.”, No. 35, pag. 293 (1987), “J. Am. Chem. Soc.”, No. 107, pag. 1431 (1985).

Typically, the synthesis is carried out in two steps, according to the following scheme:

### Step 1:

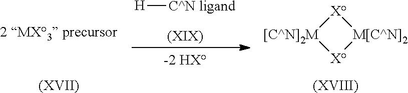

### Step 2:

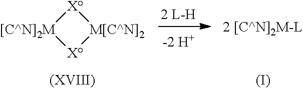

wherein X° is a halogen, preferably Cl, and M, L, CAN have the meaning as above defined.

Acid forms of the orthometalated ligands (H—ĈN) and of ancillary ligands (L-H) can be either commercially available or easily synthesized by well-known organic synthesis reaction pathways.

Should the transition metal be iridium, trihalogenated iridium (III) compounds such as IrCl₃.H₂O, hexahalogenated Iridium (III) compounds, such as M°₃IrX°₆, wherein X° is a halogen, preferably Cl and M° is an alkaline metal, preferably K, and hexahalogenated iridium (IV) compounds such as M°₂IrX°₆, wherein X° is a halogen, preferably Cl and M° is an alkaline metal, preferably K (Ir halogenated precursors, hereinafter) can be used as starting materials to synthesize the complexes of formula (I), as above described. [ĈN]₂Ir(μ-X°)₂Ir[ĈN]₂ complexes (formula XVIII, wherein M=Ir), with X° being a halogen, preferably Cl, can be thus prepared from said Ir halogenated precursors and the appropriate orthometalated ligand by literature procedures (S. Sprouse, K. A. King, P. J. Spellane, R. J. Watts, J. Am. Chem. Soc., 1984, 106, 6647-6653; M. E. Thompson et al., Inorg. Chem., 2001, 40(7), 1704; M. E. Thompson et al., J. Am. Chem. Soc., 2001, 123(18), 4304-4312).

The reaction is advantageously carried out using an excess of the neutral form of the orthometalated ligand (H—ĈN); high-boiling temperature solvents are preferred.

For the purpose of the instant invention, the term high-boiling temperature solvent is intended to denote a solvent having a boiling point of at least 80° C., preferably of at least 85° C., more preferably of at least 90° C. Suitable solvents are for instance ethoxyethanol, glycerol, dimethylformamide (DMF), N-methylpyrrolidone (NMP), dimethylsulfoxide (DMSO), and the like; said solvents can be used as such or in admixture with water.

Optionally the reaction can be carried out in the presence of a suitable Brønsted base.

[ĈN]₂IrL complexes can be finally obtained by reaction of said [ĈN]₂Ir(μ-X°)₂Ir[ĈN]₂ complex with the acid form of the ancillary ligand (L-H). The reaction:

[ĈN]₂Ir(μ-X°₂Ir[ĈN]₂+L-H→[ĈN]₂IrL+H-X°

can be carried out in a high-boiling temperature solvent or in a low-boiling temperature solvent.

Suitable high-boiling temperature solvents are notably alcohols such as ethoxyethanol, glycerol, DMF, NMP, DMSO and the like; said solvents can be used as such or in admixture with water.

The reaction is preferably carried out in the presence of a Brønsted base, such as metal carbonates, in particular potassium carbonate (K₂CO₃), metal hydrides, in particular sodium hydride (NaH), metal ethoxide or metal methoxide, in particular NaOCH₃, NaOC₂H₅.

Suitable low-boiling temperature solvents are notably chlorohydrocarbons like notably chloromethanes (eg. CH₃Cl; CH₂Cl₂; CHCl₃); dichloromethane being preferred.

Optionally, a precursor for ligand L can be used in the second step of the synthesis as above defined, which, in the reactive medium of said second step, advantageously reacts to yield the targeted L ligand.

Another object of the invention is the use of the light emitting materials as above described in the emitting layer of an organic light emitting device.

In particular, the present invention is directed to the use of the light emitting material as above described as dopant in a host layer, functioning as an emissive layer in an organic light emitting device (OLED).

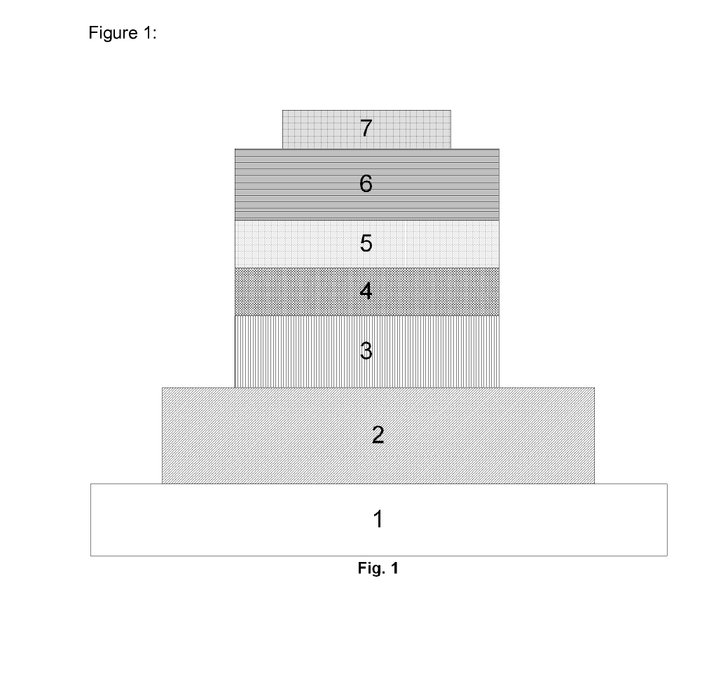

Suitable OLEDs preferably have a multilayer structure, as depicted in FIG. 1, wherein 1 is a glass substrate, 2 is an indium-tin oxide layer (ITO), 3 is a hole transporting layer (HTL), 4 is an emissive layer (EML) comprising a host material and the light emitting material as above defined as; 5 is a hole blocking layer (HBL); 6 is an electron transporting layer (ETL); and 7 is an Al layer cathode.

The emitter materials in accordance with the instant invention show a good combination of properties making them particularly suitable for the intended use in OLED devices. Of particular interest is the fact that most of the emitter materials in accordance with the invention show a stable emission in the blue range of the spectrum and thus provide a solution to a problem not satisfactorily solved before. The emission maxima of the preferred materials are in the range of from 430 to 500 nm, in particular of from 440 to 495 nm.

Furthermore, the emitter materials in accordance with the instant invention also show good electroluminescence yields, which is an additional advantage.

The following examples are merely illustrative for particularly preferred embodiments of the invention but are not limiting the invention to these embodiments. Other emitter materials can be prepared in an analogous manner.

NMR Spectroscopy

NMR spectra have been recorded using an Oxford NMR spectrometer or a Varian Mercury Plus spectrometer, both operating at 400 MHz.

Photoluminescence Spectroscopy

Photoluminescent spectra were measured on a JASCO model FP-750 spectrofluorometer. Photoluminescent spectra measurements (at concentration of from 0.001 to 0.002 mM) were carried out at room temperature in ethanol solution using excitation wavelength of 375 nm, unless otherwise specified. Emission quantum yields were determined using fac-Ir(tpy)₃ as a reference

Thin layer chromatography was performed using silica plates.

### EXAMPLE 1

### Synthesis of 2-(2,4-Difluoro-3-(2,2,2-trifluoroethanol)phenyl)pyridine (1) and 2-(2,4-Difluoro-3-(2,2,2-Trifluoroethanone)phenyl)pyridine (2)

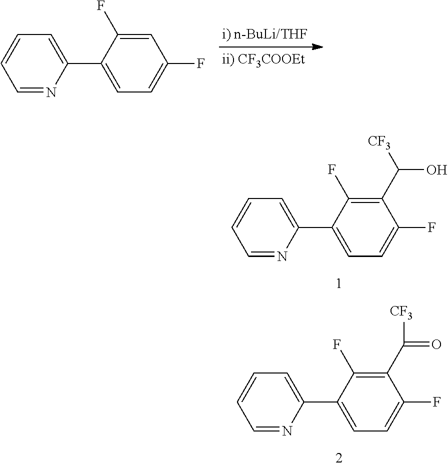

A solution of 2-(2,4-difluorophenyl)pyridine (1.7 g, 8.89 mmol, 1 eq.) in tetrahydrofurane (THF, 30 ml) was cooled to −78° C. and n-butyl lithium (n-BuLi) in Hexane (6.12 ml, 9.78 mmol, 1.1 eq.) was added dropwise to the stirred mixture for 15 min.

After having been stirred for 1 hr at about −78° C., ethyl trifluoroacetic acid (1.17 ml, 9.78 mmol, 1.1 eq) was added dropwise to the solution within 10 min.

After removal of the cooling, the temperature of the mixture increased to room temperature (23° C.) and was kept at this temperature overnight with continuous stirring.

Thereafter, water (50 ml) was added to this mixture and then the organic compounds were extracted with dichloromethane (3 times) and the organic phase was washed with brine (50 ml).

The organic extract was dried over MgSO₄, and the solvents were removed on a rotary evaporator.

The crude product was purified by column chromatography on silica gel with a 1:2 mixture of ethylacetate/hexane as the eluent to yield a pale yellow oil (1: R_{f}=0.1, 0.61 g, 24%. 2: R_{f}=0.4, 0.53 g, 21%). The yellow oil was changed to pale yellow crystal after few hours later in the air condition.

(1) ¹H NMR (400 MHz, CDCl₃): 8.73 (d, 1H), 8.04 (dd, 1H), 7.79 (t, 1H), 7.73 (d, 1H), 7.30 (t, 1H), 7.11 (t, 1H), 5.47 (bs, 1H), 3.51 (bs, 1H).

(2) ¹H NMR (400 MHz, CDCl₃): 8.73 (d, 1H), 8.31 (dd, 1H), 7.80 (t, 1H), 7.78 (s, 1H), 7.32 (t, 1H), 7.18 (t, 1H).

### 2-(2,4-Difluoro-3-(2,2,2-Trifluoroethanone)phenyl)pyridine (2)

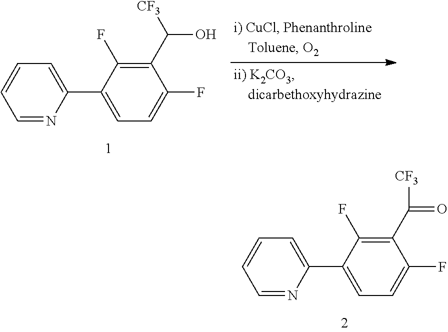

A 25 mL, two-necked flask was fitted with a reflux condenser and an oxygen inlet. Toluene (15 ml) was added followed sequentially by CuCl (0.010 g, 0.10 mmol, 5% eq.) and 1.10-phenanthroline (0.019 g, 0.10 mmol, 5% eq.). The stirring was continued until the color of solution changed to transparent black at room temperature for 20 min.

Thereafter, 1,2-Dicarbethoxyhydrazine (0.09 g, 0.52 mmol, 25% eq.) was added followed by solid K₂CO₃ (0.56 g, 4.15 mmol, 2 eq) and the stirring was continued for another 10 min.

2-(2,4-Difluoro-3-(2,2,2-Trifluoroethanol)phenyl)pyridine (1: 0.6 g, 2.07 mmol, 1 eq.) was added neat, and the solution was heated to reflux condition with oxygen bubbling.

After 2 hr, the reaction was found to be complete by thin-layer chromatography (TLC), the mixture was cooled to room temperature and the solvent was evaporated in vacuo.

The crude product was purified by chromatography on silica gel with CH₂Cl₂ as the eluent to yield yellow oil (0.52 g, 87%).

### EXAMPLE 2

### Synthesis of Compound 3

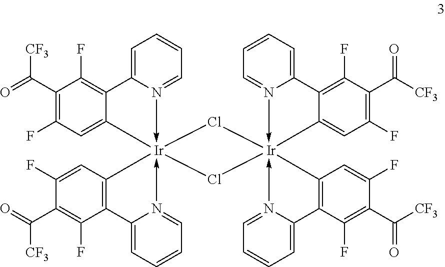

IrCl₃.nH2O (1 eq) was dissolved in 2-ethoxyethanol and degassed with argon at 75° C. for 30 min. Then 2.2 equiv of cyclometalating ligand (CAN) were added directly. The mixture was heated to 125° C. for 18 h under argon and protected from light with an aluminum foil. After cooling to about 50° C., solvent was reduced to half volume under vacuum. After cooling to room temperature, the mixture was poured into Erlenmeyer containing deionized water. The flask was stored in the fridge (about 6° C.) for 4 hours. The precipitate was isolated by vacuum filtration through a fitted glass and washed copiously with water. The yellow solid was vaccuum-dried at room temperature overnight, protected from light with an aluminum foil, to yield compound 3 as a yellow solid.

¹H-NMR (CDCl₃, 400 MHz): 9.08 (d, 4H); 8.41 (d, 4H); 7.99 (t, 4H); 6.97 (t, 4H); 5.42 (d, 4H).

### EXAMPLE 3

### Synthesis of Compound 4

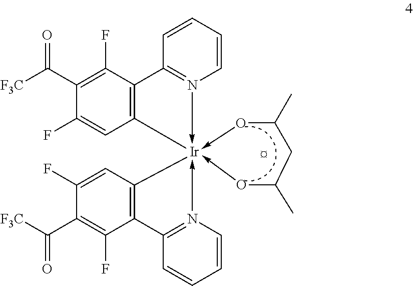

A mixture of acetylacetone (4 eq.) and TBAOH (3 eq.) in dichloromethane was refluxed at 40° C. for half an hour and cooled down to 30° C. Compound 3 (1 eq.) was dissolved in dichloromethane and added to the TBA acetylacetonate mixture. The mixture was heated at 30° C. for 12 hours under argon protected from light with an aluminum foil. The mixture was cooled to room temperature and deposited on top of a silica column (SiO₂/CH₂Cl₂). The product was eluted using CH₂Cl₂/acetone 0 to 25% to yield compound 4 as a yellow powder.

¹H-NMR (CDCl₃, 400 MHz): 8.43 (d, 2H); 8.34 (d, 2H); 7.94 (t, 2H); 7.34 (t, 2H); 5.83 (d, 2H); 5.30 (s, 1H); 1.82 (s, 6H).

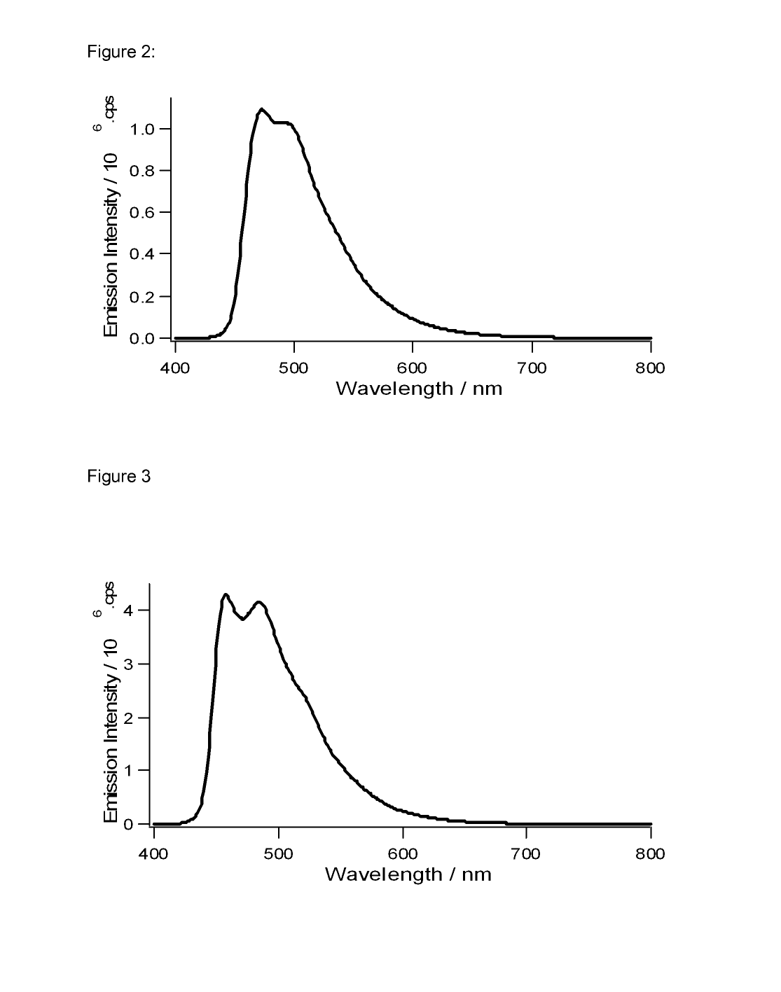

FIG. 2 shows the emission spectrum of compound 4 after excitation at 375 nm.

### EXAMPLE 4

### Synthesis of Compound 5

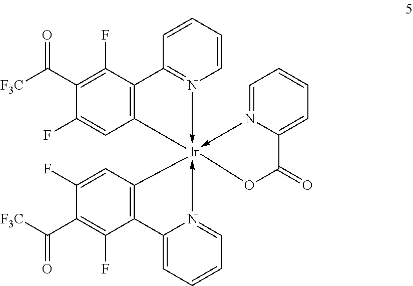

A mixture of picolinic acid (4 eq.) and TBAOH (3 eq.) in dichloromethane was refluxed at 40° C. for half an hour and cooled down to 30° C. Compound 3 (1 eq.) was dissolved in dichloromethane and added to the TBA picolinate mixture. The mixture was heated at 30° C. for 12 hours under argon protected from light with an aluminum foil. The mixture was cooled to room temperature and deposited on top of a silica column (SiO₂/CH₂Cl₂). The product was eluted using CH₂Cl₂/acetone 0 to 25% to yield Compound 5 as a yellow powder.

¹H-NMR (CDCl₃, 400 MHz): 8.78 (d, 1H); 8.38 (m, 2H); 8.33 (d, 1H); 8.03 (t, 1H) 7.92 (t, 2H); 7.76 (d, 1H); 7.53 (t, 1H); 7.45 (d, 1H); 7.35 (t, 1H); 7.13 (t, 1H); 6.02 (d, 1H); 5.72 (d, 1H);

FIG. 3 shows the emission spectrum of compound 5 after excitation at 375 nm

### EXAMPLE 5

### Synthesis of Compound 6

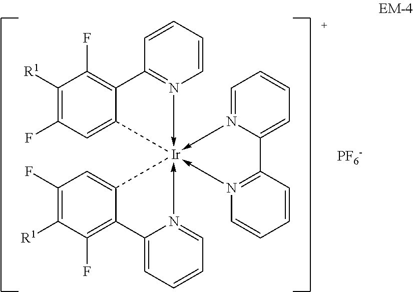

A mixture of bipyridine (4 eq.) and compound 3 (1 eq.) was dissolved in dichloromethane and refluxed overnight under argon. The solvents were evaporated and the mixture was dissolved in the minimum of dichloromethane and then poured into diethyl ether. The precipitate was filtered and washed with diethylether. The solid was dissolved in acetone and a saturated aqueous solution of ammonium hexafluorophosphate was added. The acetone was gently removed under vacuum and the precipitate filtered, washed with water and dried to yield compound 6 as a pale blue solid.

¹H-NMR (CDCl₃, 400 MHz): 8.70 (d, 2H); 8.39 (d, 2H); 8.25 (t, 2H); 7.92 (m, 4H) 7.62 (d, 2H); 7.57 (t, 2H); 7.28 (d, 2H); 5.86 (d, 2H).

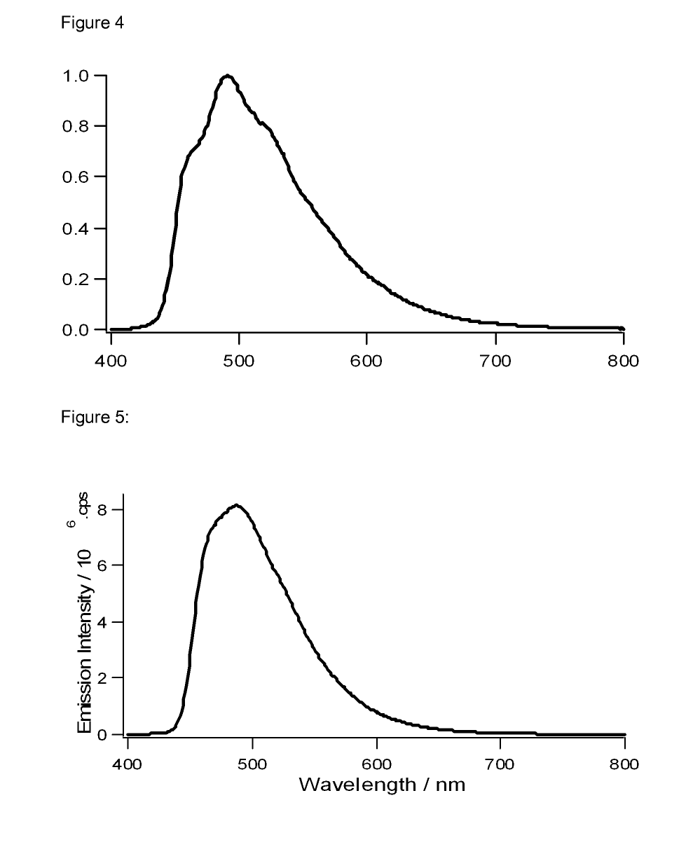

FIG. 4 shows the emission spectrum of compound 6 after excitation at 375 nm.

### EXAMPLE 6

### Synthesis of 3-(2,4-difluorophenyl)-5,6,7,8-tetrahydroisoquinoline (7)

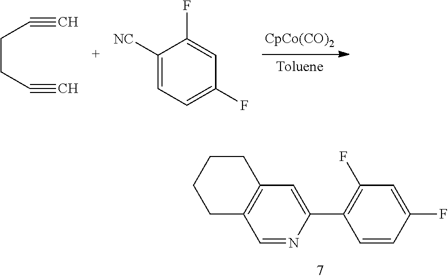

A 500 ml two-necked flask was fitted with reflux condenser under the dropping funnel and an Ar inlet. 1,7-Octadiyne (1.05 ml, 7.91 mmol, 0.25 eq.) was added to flask after drying the 2,4-difluorobenzonitrile (4.4 g, 31.6 mmol, 1 eq.) in vacuo, then distilled toluene (200 ml) was added to this mixture. Toluene (150 ml) was added followed sequentially by 1,7-octadiyne (3.15 ml, 23.7 mmol, 0.75 eq.) and CpCo(CO)₂ (0.28 g, 1.58 mmol, 5% eq.) to dropping funnel.

The toluene solution with catalyst was added dropwise for 36 hr to another mixture solution in flask under reflux condition with hv (200 W) and Ar bubbling. The color of the solution changed to dark brown after addition of the catalyst.

After finishing the dropwise addition, the stirring was continued for another 12 hr under the same conditions.

The mixture was cooled to room temperature and the solvent was removed on a rotary evaporator.

The crude product was purified by chromatography on silica gel with CH₂Cl₂ (R_{f}=0.2) as the eluent to yield a pale brown oil (3.2 g, 41%). The Pale brown crystallized after a few hours in air.

¹H NMR (400 MHz, CDCl₃): 8.38 (s, 1H), 7.92 (q, 1H), 7.41 (s, 1H), 6.96 (t, 1H), 6.89 (t, 1H), 2.79 (d, 4H), 1.84 (t, 4H).

### EXAMPLE 7

### Synthesis of 3-(2,4-Difluoro-3-(2,2,2-Trifluoroethanol)phenyl)-5,6,7,8-tetrahydroisoquinoline (8) and 3-(2,4-Difluoro-3-(2,2,2-Trifluoroethanone)phenyl)-5,6,7,8-tetrahydroisoquinoline (9)

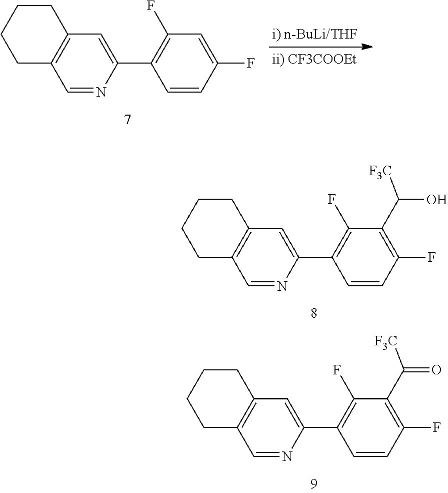

A solution of 3-(2,4-difluorophenyl)-5,6,7,8-tetrahydroisoquinoline 7 (2 g, 8.15 mmol, 1 eq.) in THF (50 ml) was cooled to −78° C. and n-BuLi in Hexane (5.6 ml, 8.97 mmol, 1.1 eq.) was added dropwise to the stirred mixture for 15 min.

After removal of the cooling, the temperature of the mixture increased to room temperature (23° C.) and was kept at this temperature overnight with continuous stirring.

Thereafter, water (50 ml) was added to this mixture and then the organic compounds were extracted with dichloromethane (3 times) and the organic phase was washed with brine (50 ml).

The organic extract was dried over MgSO₄, and the solvents were removed on a rotary evaporator.

The product was purified by column chromatography on silica gel with a 1:2 mixture of ethylacetate/hexane as the eluent to yield as a yellow oil (8: R_{f}=0.4, 1.13 g, 40%. 9: R_{f}=0.2, 0.51 g, 18%).

(8) ¹H NMR (400 MHz, CDCl₃): 8.34 (s, 1H), 7.68 (q, 1H), 7.28 (s, 1H), 6.89 (t, 1H), 5.35 (q, 1H), 4.10 (q, 1H), 2.77 (d, 4H), 1.82 (t, 4H).

(9) ¹H NMR (400 MHz, CDCl₃): 8.40 (s, 1H), 8.24 (q, 1H), 7.44 (s, 1H), 7.14 (t, 1H), 2.80 (d, 4H), 1.86 (t, 4H).

### EXAMPLE 8

### Synthesis of 3-(2,4-difluoro-3-(2,2,2-trifluoroethanone)phenyl-5,6,7,8-tetrahydroisoquinoline (9)

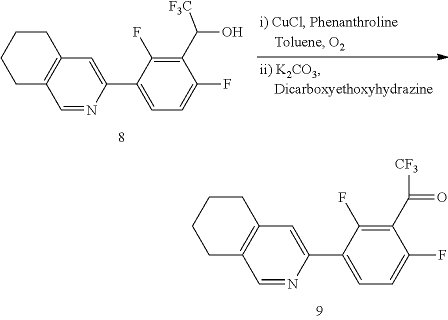

A 25 mL, two-necked flask was fitted with a reflux condenser and an oxygen inlet. Toluene (15 ml) was added followed sequentially by CuCl (0.014 g, 0.15 mmol, 5% eq.) and 1,10-phenanthroline (0.026 g, 0.15 mmol, 5% eq.).

The stirring was continued until the color of the solution had changed to transparent black at room temperature for 20 min.

1,2-Dicarbethoxyhydrazine (0.13 g, 0.73 mmol, 25% eq.) was added followed by solid K₂CO₃ (0.81 g, 5.83 mmol, 2 eq) and the stirring was continued for another 10 min.

2-(2,4-Difluoro-3-(2,2,2-Trifluoroethanol)phenyl)pyridine (8: 1.0 g, 2.91 mmol, 1 eq.) was added neat, and the solution was heated to reflux condition with oxygen bubbling.

After 3 hr, the reaction was found to be complete by TLC, the mixture was cooled to room temperature and the solvent was evaporated in vacuo.

The crude product was purified by chromatography on silica gel with a 1:2 mixture of ethylacetate/hexane as the eluent to yield compound 9 as a yellow oil (R_{f}=0.2, 0.41 g, 41%).

### EXAMPLE 9

### Synthesis of Compound 10

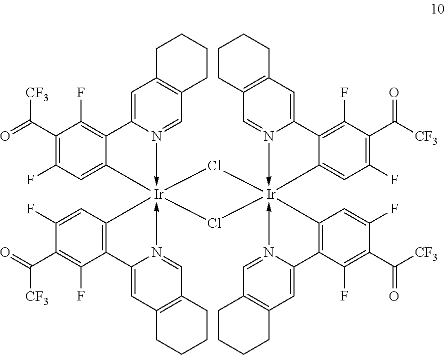

IrCl₃ nH2O (1 eq) was dissolved in 2-ethoxyethanol and degassed with argon at 75° C. for 30 min. Then 2.2 equiv of cyclometalating ligand (CAN) were added directly. The mixture was heated to 125° C. for 18 h under argon and protected from light with an aluminum foil. After cooling to about 50° C., solvent was reduced to half volume under vacuum. After cooling to room temperature, the mixture was poured into Erlenmeyer containing deionized water. The flask was stored in the fridge (about 6° C.) for 4 hours. The precipitate was isolated by vacuum filtration through a fitted glass and washed copiously with water. The yellow solid was vacuum-dried at room temperature overnight, protected from light with an aluminum foil, to yield compound 10 as a yellow solid.

¹H-NMR (CDCl₃, 400 MHz): 8.92 (s, 4H); 7.76 (s, 4H); 5.69 (d, 4H); 3.07 (m, 1H); 2.89 (m, 1H); 2.60 (m, 1H); 2.42 (m, 1H); 1.83 (m, 2H); 1.70 (m, 2H).

### EXAMPLE 10

### Synthesis of Compound 11

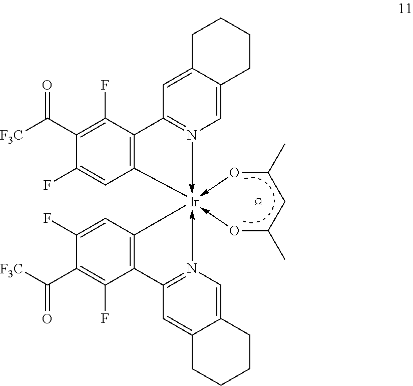

A mixture of acetylacetone (4 eq.) and TBAOH (3 eq.) in dichloromethane was refluxed at 40° C. for half an hour and cooled down to 30° C. Compound 10 (1 eq.) was dissolved in dichloromethane and added to the TBA acetylacetonate mixture. The mixture was heated at 30° C. for 12 hours under argon protected from light with an aluminum foil. The mixture was cooled to room temperature and deposited on top of a silica column (SiO₂/CH₂Cl₂). The product was eluted using CH₂Cl₂/acetone 0 to 25% to yield compound 11 as a yellow powder.

¹H-NMR (CDCl₃, 400 MHz): 8.04 (s, 2H); 8.00 (s, 2H); 5.84 (d, 2H); 5.27 (s, 1H); 3.05 (m, 4H); 2.80 (m, 4H); 1.92 (m, 8H); 1.83 (s, 6H).

FIG. 5 shows the emission spectrum of compound 11 after excitation at 375 nm.

### EXAMPLE 11

### Results with Compound 5 in an OLED Device

### Spincoated OLEDs

OLED Structure:

### ITO/CH8000/PVK:OXD7:EB 166/TPBI/Cs2CO3/Al

Compound 5 (example 4)—various concentrations: 1.5% w; 2.5% w; 5% w and 10% w.

Poly(9-vinylcarbazole) (PVK, Mw=1.100.000) and OXD-7 (1,3-bis[2-(4-tert-butylphenyl)-1,3,4-oxadiazo-5-yl]benzene) were obtained from SP2 and Luminescence Technology Corp., respectively. Poly(3,4-ethylenedioxythiophene):poly(styrenesulfonate) (PEDOT:PSS, Clevios CH8000) and 1,3,5-tris[N-(phenyl)benzimidazole]benzene (TPBI) were purchased from HC Starck and from Luminescence Technology Corp. respectively. The device structure consisted of a 120 nm transparent ITO (indium/tin oxide) layer as the bottom electrode, supported on a glass substrate. The PEDOT:PSS layer and the emissive layer were spun in sequence on top of ITO, using a Delta6 RC spincoater from Suss Microtec. Then, TPBI, Cs₂CO₃ and the aluminum top metal contact were evaporated in sequence using a Lesker Spectros system. The ITO surface was pre-treated with O₂-plasma cleaner prior to any further processing. The emissive layer was spun from a chlorobenzene solution of PVK:OXD7 and different mass ratios of compound 5. The OLEDs were characterized optically and electrically with a C9920-12 External Quantum Efficiency Measurement System from HAMAMATSU.

The maximum efficiency obtained was 0.91%, 1.2 Cd/A and 0.74 lm/W with a doping of 1%. The turn-on voltage was 6 V. The devices containing compound 5 as emissive material showed deeper blue colour coordinates compared to standard emitter Flrpic.

The CIE coordinates were as follows:

### Compound 5: (0.17; 0.28)

### Flrpic (0.18, 0.39)

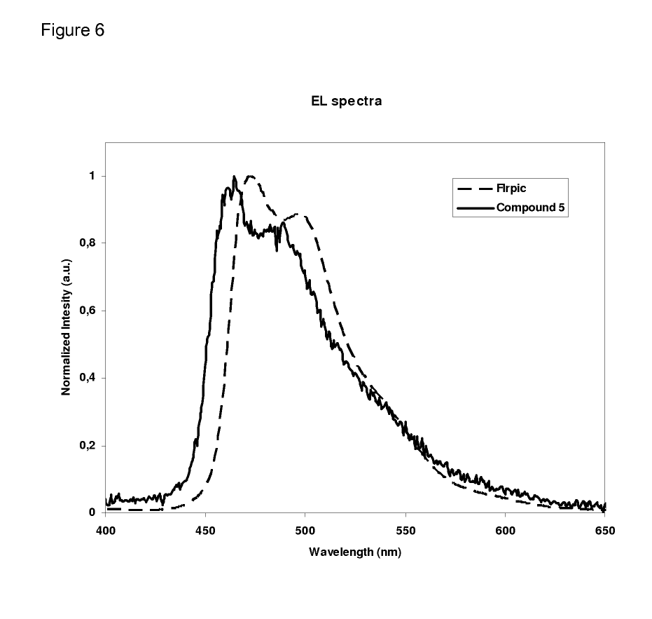

The electroluminescence spectrum is given in FIG. 6.

### Evaporated OLED's

OLED structure:

### ITO/AI 4083/NPD/mCP:Compound 5/TPBI/Cs₂CO₃/Al

Emissive layer (EML):
1) mCP:Compound 5. The doping concentration of compound 5 was 7% w.
2) TPBI:Compound 5. The doping concentration of compound 5 was 10% w. PEDOT:PSS (Clevios AI 4083) was purchased from HC Starck. NPD (N,N′-bis[naphthalene-1-yl]-N,N′-bis[phenyl]-benzidine) and mCP (1,3-bis[carbazole-9-yl]benzene) were purchased from Luminescence Technology Corp. NPD, mCP:Compound 5, TPBI, Cs₂CO₃ and the aluminum top metal contact were evaporated in sequence using a Lesker Spectros system.

The maximum efficiencies were reached with TPBi as host and they reached 1.84%, 3.63 Cd/A and 1.81 lm/W. Turn-on voltage was around 5.5 V.

CIE coordinates: 0.15; 0.26

1. A light emitting material comprising a complex of formula I
(L¹)ₓ-M-(L²)_{y} (I)
wherein L¹ is a mono-anionic bidentate carbon-coordinating ligand comprising the structural element 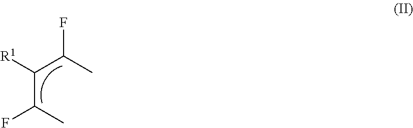
in a ring system, wherein R1 is a substituent selected from the group consisting of R₁-1 to R₁-8, said R₁-1 to R₁-8 being defined as follows: 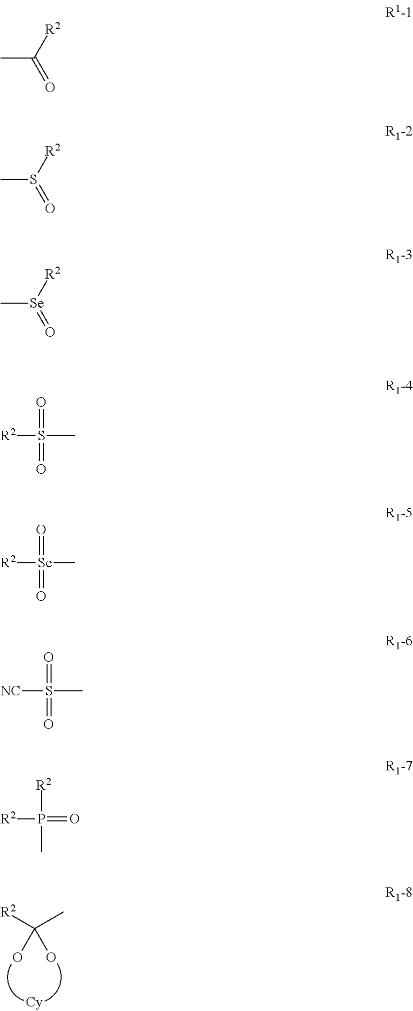
wherein:
R² represents a substituted linear, branched or cyclic alkyl chain having 1 to 20 carbon atoms or an optionally substituted alkoxy group with 1 to 20 carbon atoms,
Cy represents a 4 to 7 membered carbocyclic or heterocyclic ring, which may be partially or fully substituted by substituents selected from the group consisting of optionally substituted linear, branched or cyclic alkyl or alkoxy chains with 1 to 20 carbon atoms,
L² is a non-mono anionic, non-bidentate or non-carbon coordination ligand,
M represents a transition metal with an atomic number of at least 40, and
x is an integer of from 1 to 3 and y is zero, 1 or 2.

2. The light emitting material in accordance with claim 1, wherein the transition metal selected from the group consisting of Re, Os, Ir, Pt, Au, Ru, Rh, Pd, and Cu.

3. The light emitting material in accordance with claim 1 wherein the transition metal is Ir or Pt.

4. The light emitting material in accordance with claim 1 wherein L¹ has the formula III 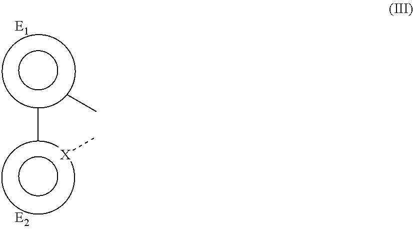
wherein:
E₁ represents a nonmetallic atoms group required to form a 5- or 6-membered carbocyclic or heterocyclic ring, optionally condensed with additional aromatic moieties or non-aromatic cycles, said ring optionally having one or more substituents, optionally forming a condensed structure with the ring comprising E₂, said ring E₁ coordinating to the metal M via a sp² hybridized carbon, and said ring E₁ comprising the structural element (II) as defined in claim 1;
E₂ represents a nonmetallic atoms group required to form a 5- or 6-membered heterocyclic ring, optionally condensed with additional aromatic moieties or non aromatic cycles, said ring optionally having one or more substituents, optionally forming a condensed structure with the ring comprising E₁, said ring E₂ coordinating to the metal M via a sp² hybridized nitrogen; and
X represents a coordinating atom selected from the group consisting of groups IVa, Va, and VIa of the periodic system.

5. The light emitting material in accordance with claim 4 wherein X is selected from the group consisting of C, N, O, S, Se, Te, and P.

6. The light emitting material in accordance with claim 5 wherein E₁ is a 2,4-difluorosubstituted phenyl ring of the formula V 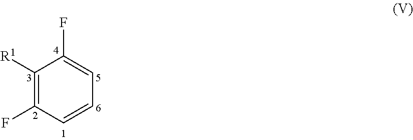
wherein the bonds to the heavy metal atom and to E₂ are through neighboring carbon atoms.

7. The light emitting material in accordance with claim 6 wherein said E₂ is an optionally substituted pyridine ring attached to ring E₁ through carbon atom 2.

8. The light emitting material in accordance with claim 1 wherein said ligand L¹ is selected from the group of compounds consisting of L¹-1 to L¹-35, said L¹-1 to L¹-35 being defined as follows:

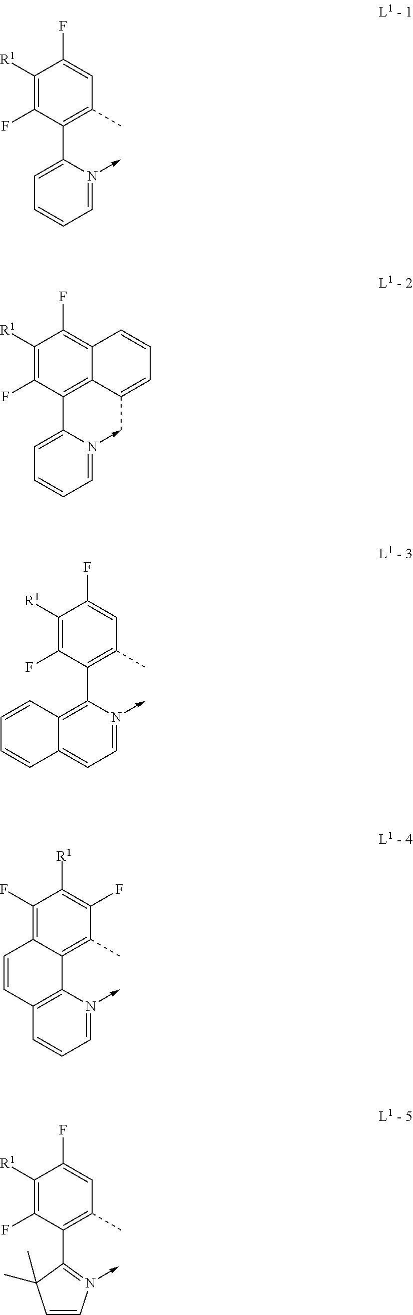

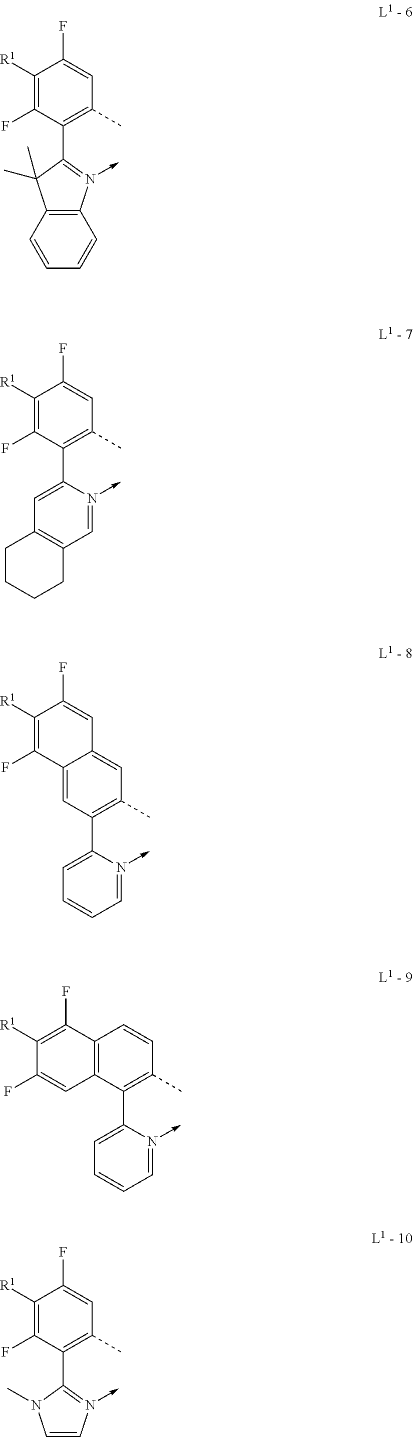

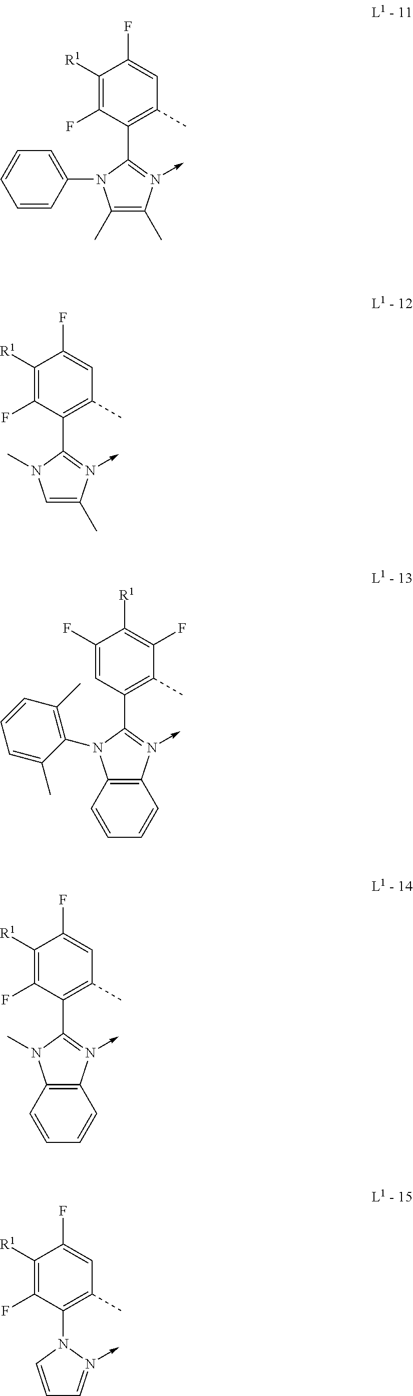

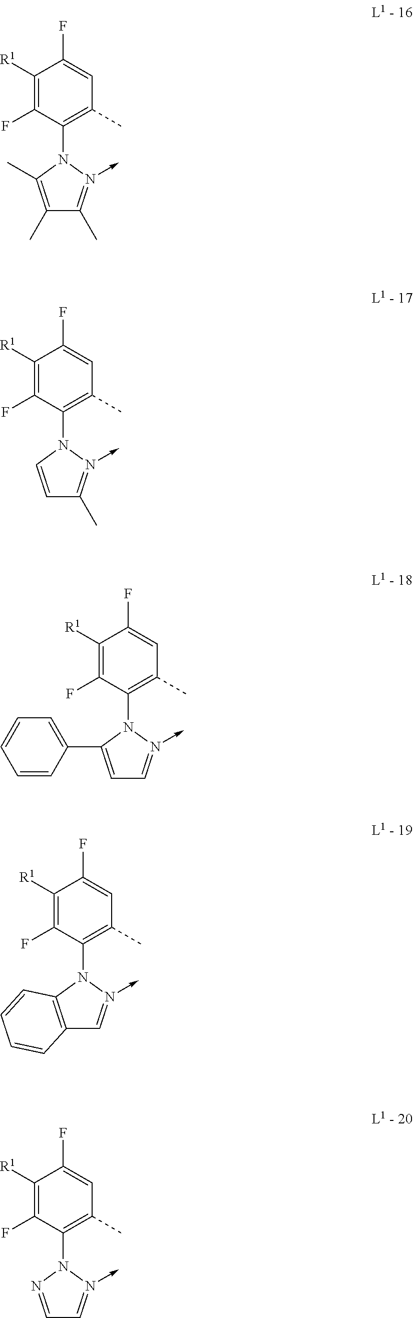

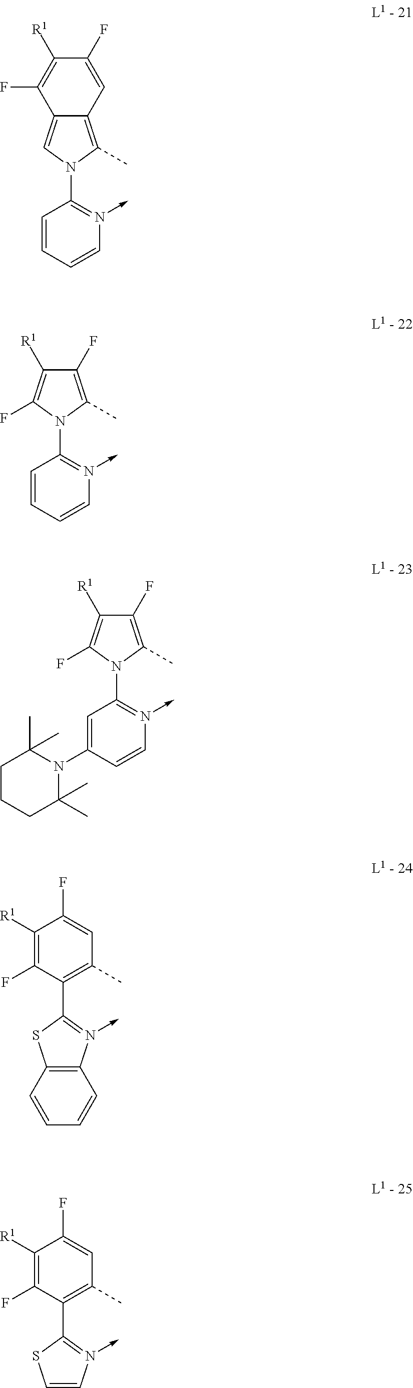

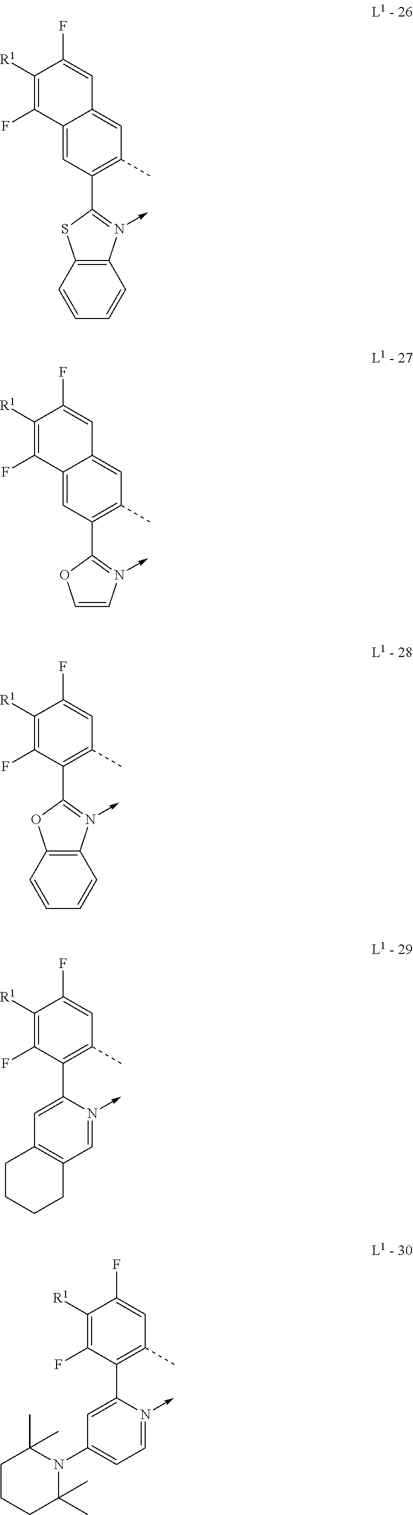

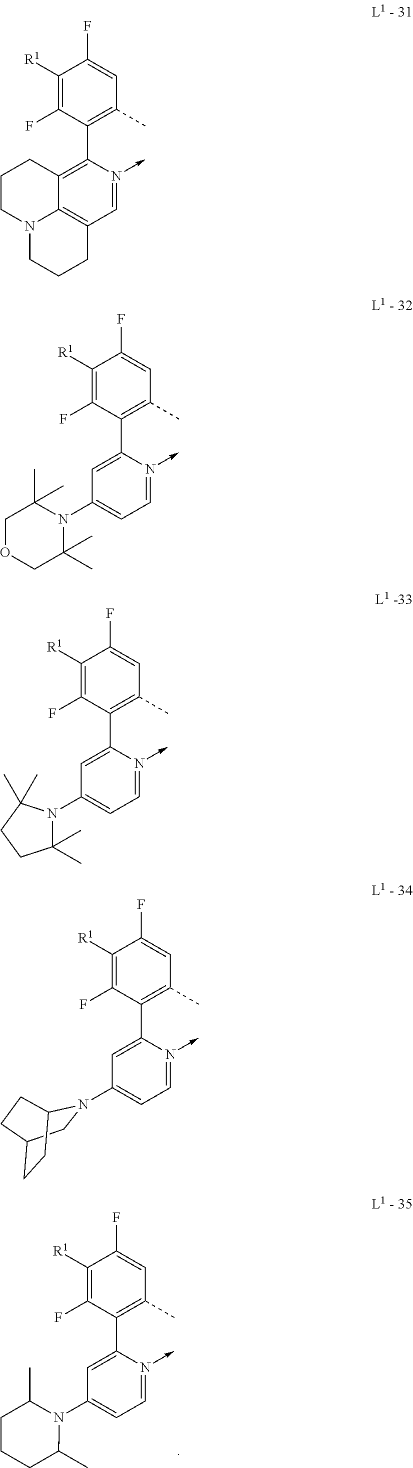

9. The light emitting material in accordance with claim 6 wherein said ligand L¹ is selected from the group consisting of L¹-1 and L¹-29 to L¹-35, said L¹-1 and L¹-29 to L¹-35 being defined as follows:

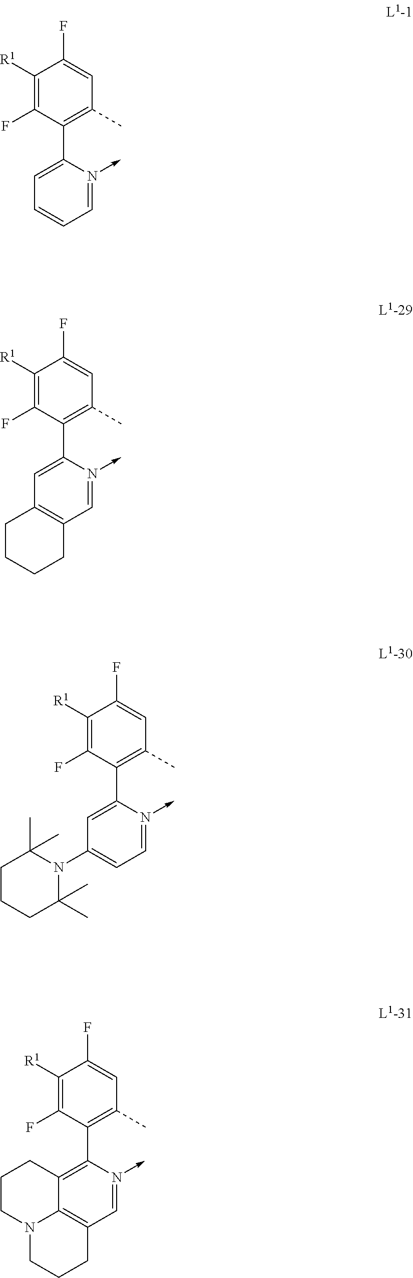

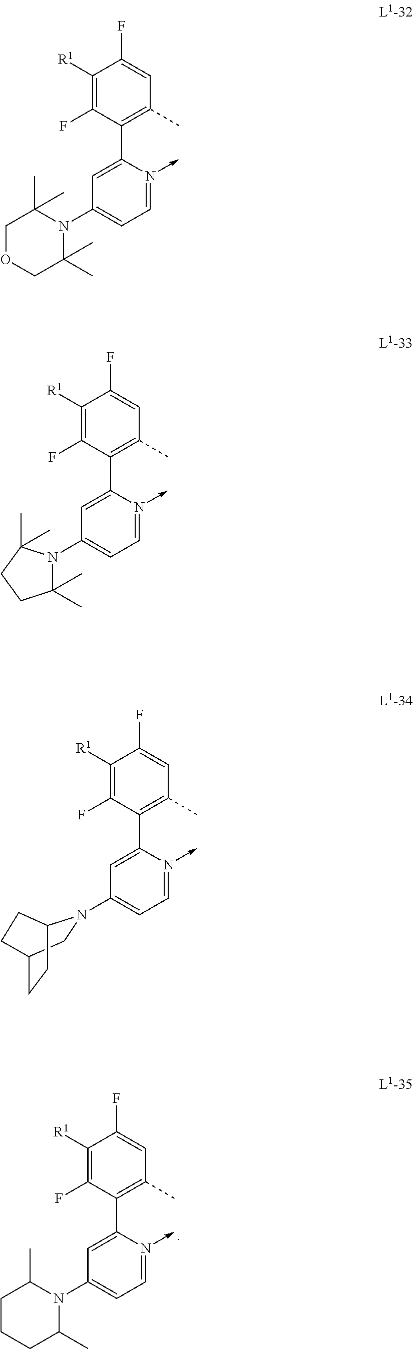

10. The light emitting material in accordance with claim 1 wherein L² has one of formulae selected from the group consisting of L²-1 to L²-7, U-1 to U-8, PL, and L²-8 to L²-27;
L²-1 to L²-7 being defined as follows: 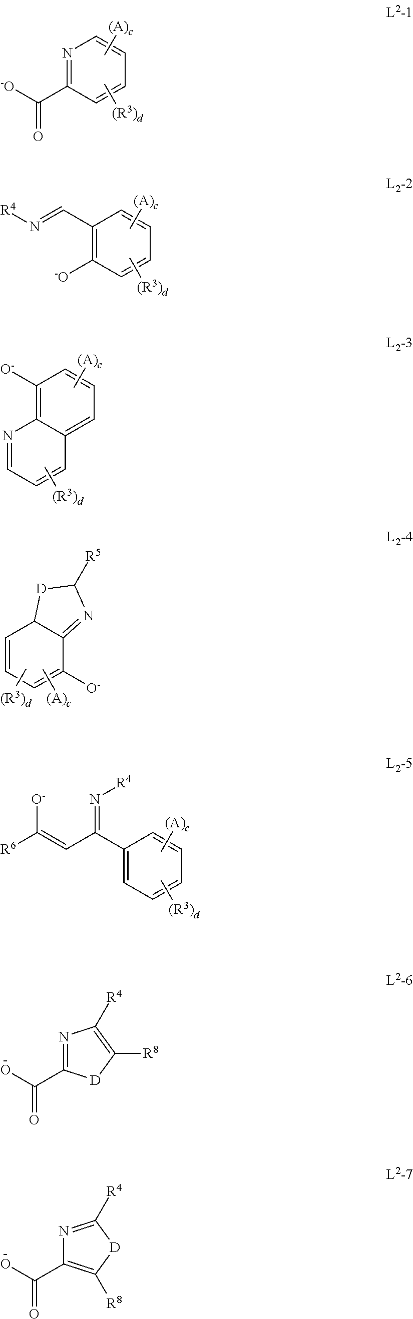
wherein:
A is a substituent selected from the group consisting of halogens —OR₇; —SR₇; —N(R₇)₂; —P(OR₇)₂ and —P(R⁷)₂; wherein R₇ is a C₁-C₆ alkyl, fluoro- or perfluoroalkyl group or a C₁-C₆ alkyl, fluoro- or perfluoroalkyl having one or more ether groups;
D is a group selected from the group consisting of —CHR⁸—, —CR⁸R⁸—, —CR⁸═CH—, —CR⁸═CR⁸—, N—H, N—R⁹, O, S and Se;
R³, R⁵, R⁶ are the same or different from each other and at each occurrence, represent F, Cl, Br, NO₂, CN, or a straight-chain or branched or cyclic alkyl or alkoxy group having from 1 to 20 carbon atoms, in each of which one or more nonadjacent —CH₂— groups may be replaced by —O—, —S—, —NR⁹—, or —CONR¹⁹—, and in each of which one or more hydrogen atoms may be replaced by F; or an aryl or heteroaryl group having from 4 to 14 carbon atoms which may be substituted by one or more nonaromatic radicals —R′; and a plurality of substituents R′, either on the same ring or on the two different rings, may in turn together form a further mono- or polycyclic ring system, optionally aromatic;
R⁴, R⁸, R⁹ and R¹⁰ are the same or different from each other and at each occurrence and are each H or an aliphatic or aromatic hydrocarbon radical, optionally substituted, having from 1 to 20 carbon atoms;
c is an integer from 1 to 3;
d is an integer from 0 to 4;
U-1 to U-8 being defined as follows: 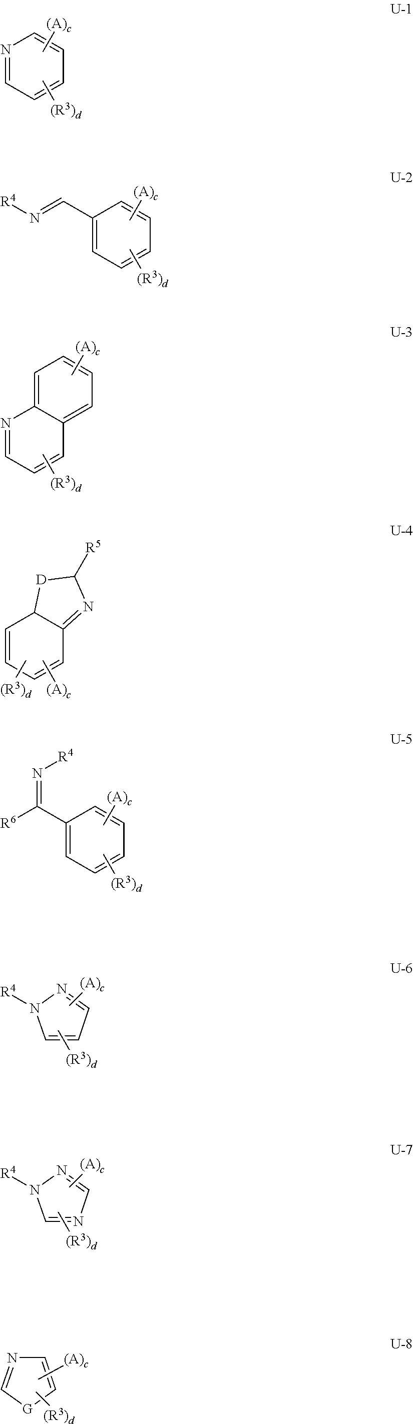
wherein A, D and R³ to R¹⁰ have the same meaning as defined hereinbefore with regard to ligands L²-1 to L²-5;
G is a group selected from the group consisting of —CH═CH—, —CR⁸═CH—, —CR⁸═CR⁸—, N—H, N—R⁹, and CR⁸═N—;
c is an integer of from 0 to and
d is an integer of from 0 to 3,
wherein R⁸ and R⁹ have the same meaning as defined before;
PL being defined as follows: 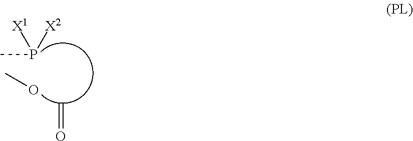
wherein X¹ and X² are the same or different and are selected from the group consisting of C₁-C₈-alkyl, aryl, heteroaryl, which may optionally be substituted by one or more substituents; and
L²-8 to L²-27 being defined as follows: 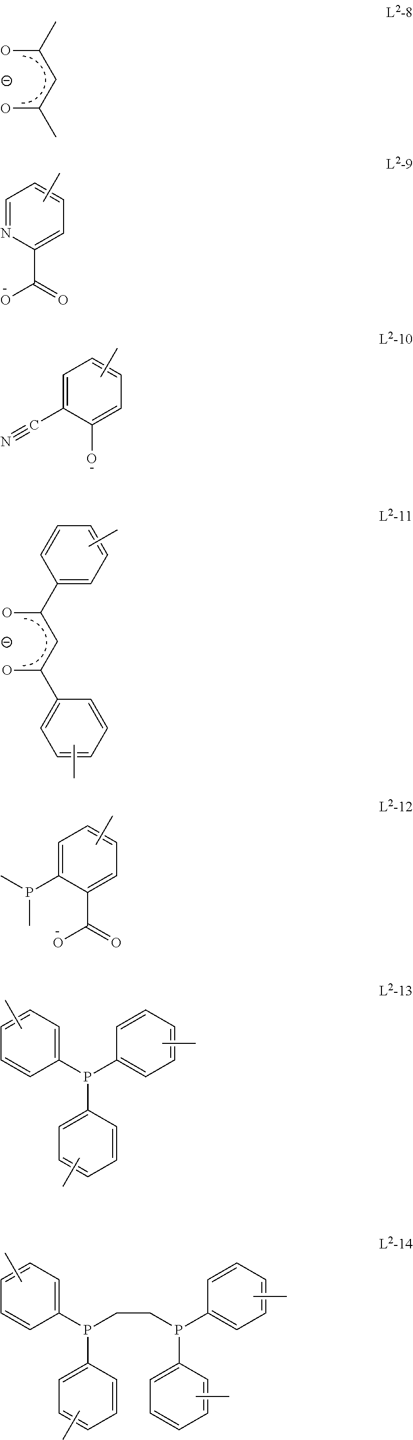 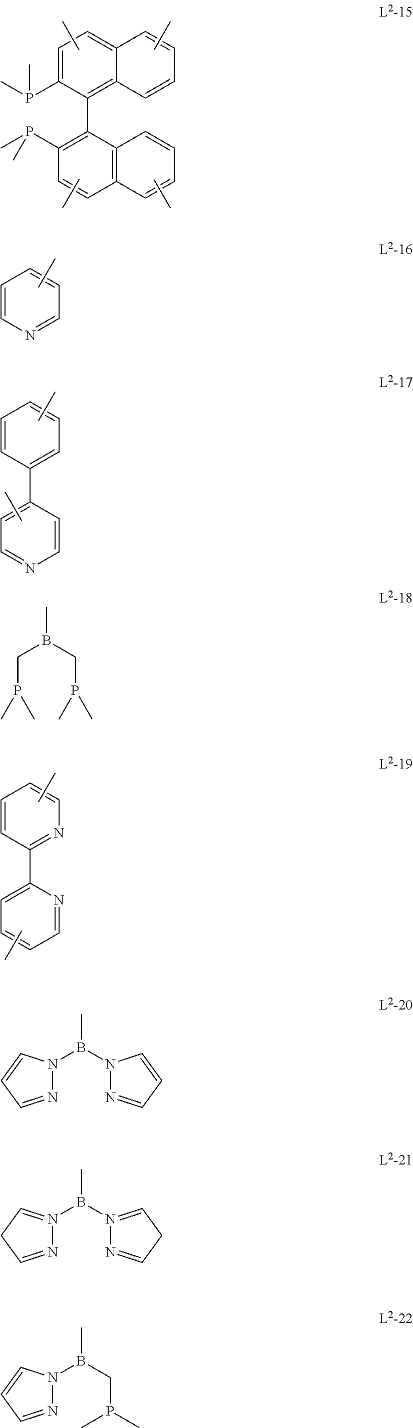 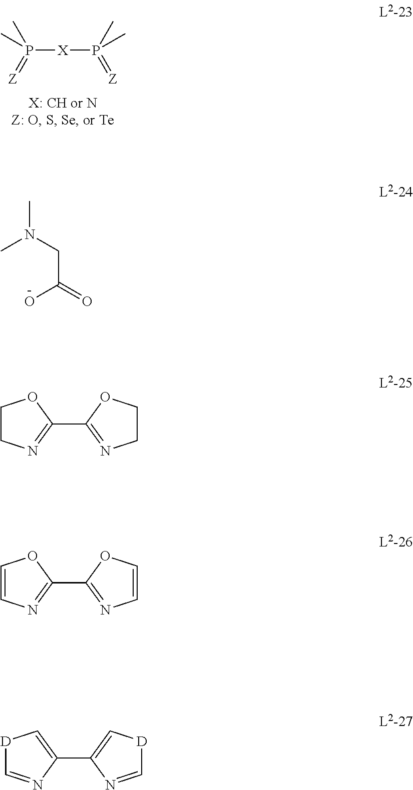
wherein in structures L²-8 to L²-27 any substituent depicted by a bond symbol may be independently selected from the group consisting of hydrogen, halogen, C₁-C₈-alkyl, and an aryl group.

11. The light emitting material in accordance with claim 1 selected from the group consisting of compounds EM-1 to EM-5, said compounds EM-1 to EM-5 being defined as follows: 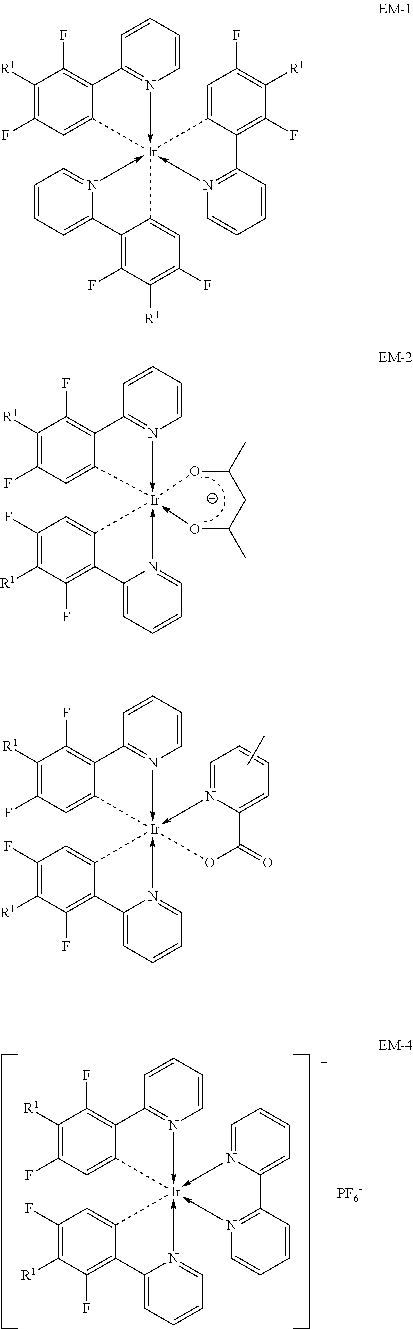 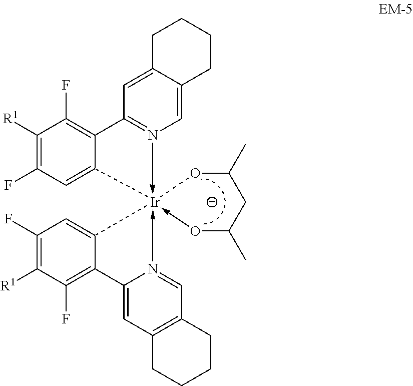
wherein in structures EM-1 to EM-5 any substituent depicted by a bond symbol may be independently selected from the group consisting of hydrogen, halogen, C₁-C₈-alkyl, and an aryl group.

12. A method for emitting light, comprising using the light emitting material in accordance with claim 1 in an emitting layer of an organic light emitting device.

13. A method for emitting light, comprising using the light emitting material in accordance with claim 1 as a dopant in a host layer in an organic light emitting device for the host layer to function as an emissive layer in the organic light emitting device.

14. An organic light emitting device (OLED) comprising an emissive layer, said emissive layer comprising the light emitting material in accordance with claim 1.

15. The light emitting material in accordance with claim 8 wherein the transition metal is Ir.

16. The light emitting material in accordance with claim 10 wherein the transition metal is Ir.

17. The light emitting material in accordance with claim 10 wherein the transition metal is Ir, and wherein said ligand L¹ is selected from the group consisting of compounds L¹-1 to L¹-35, said L¹-1 to L¹-35 being defined as follows:

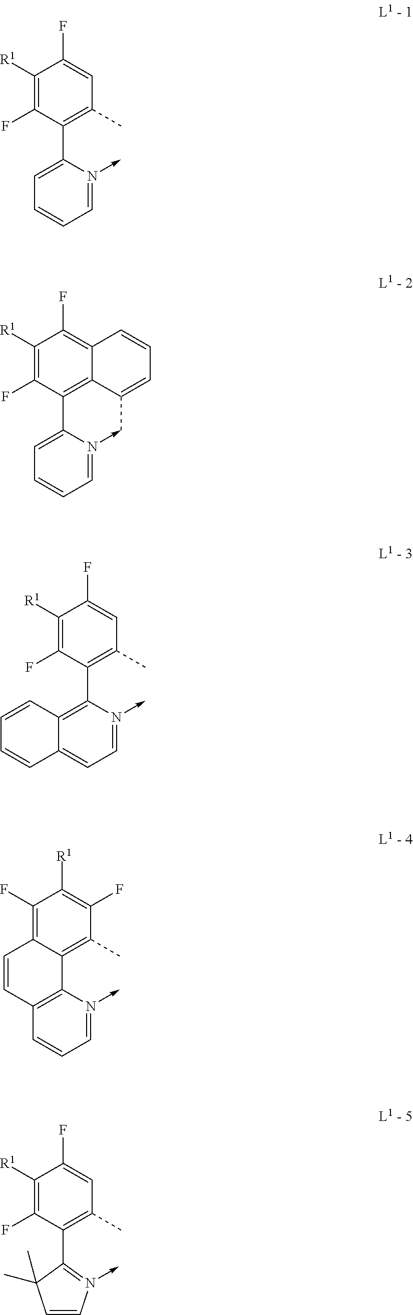

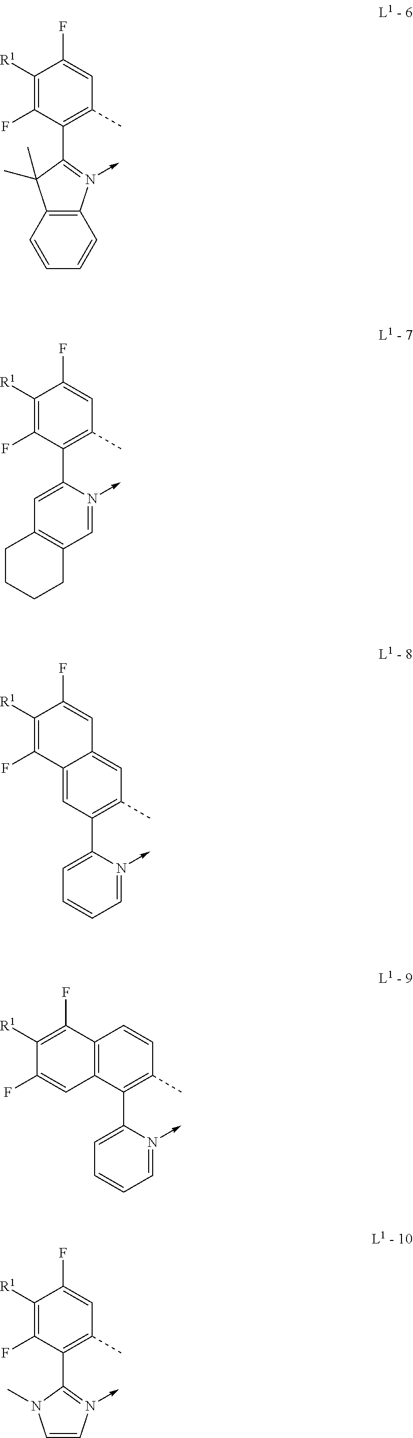

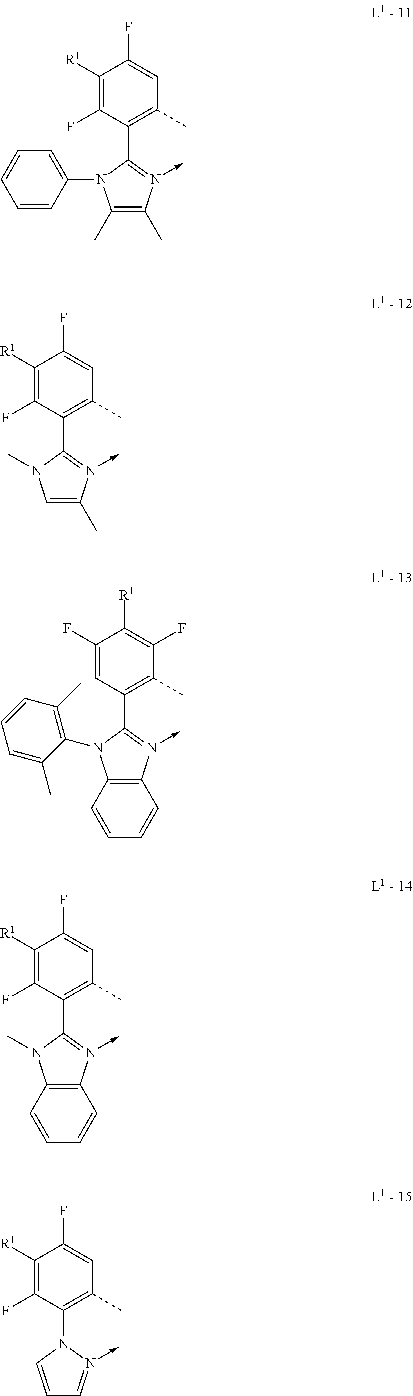

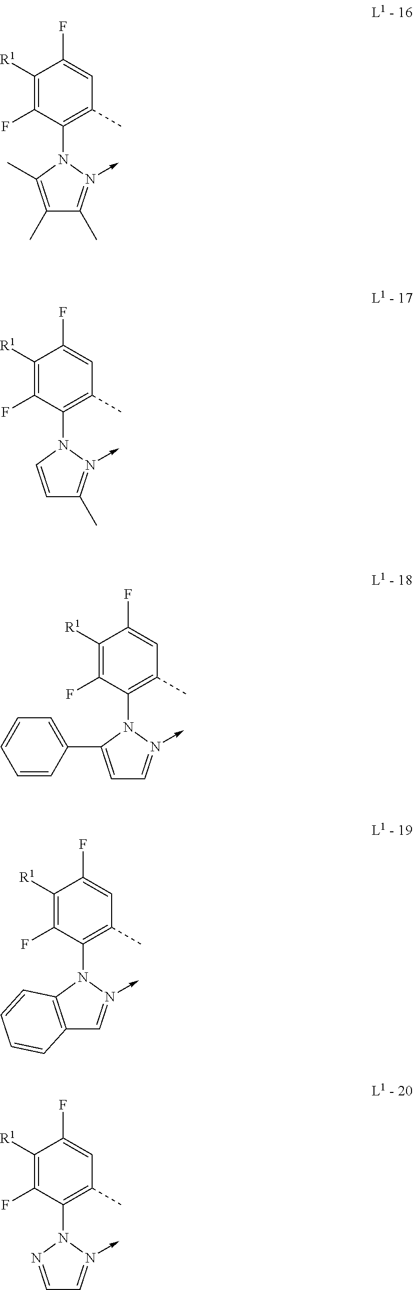

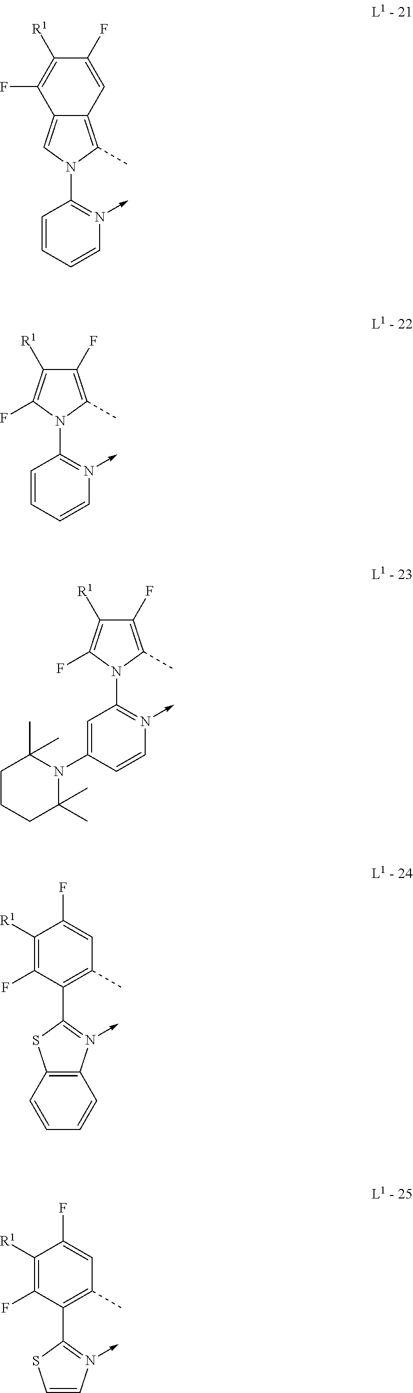

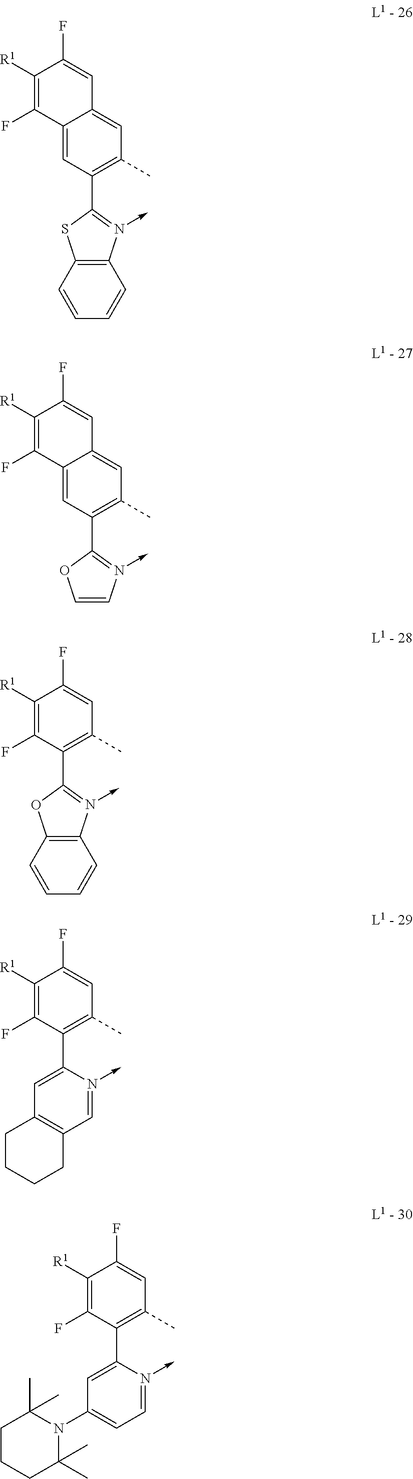

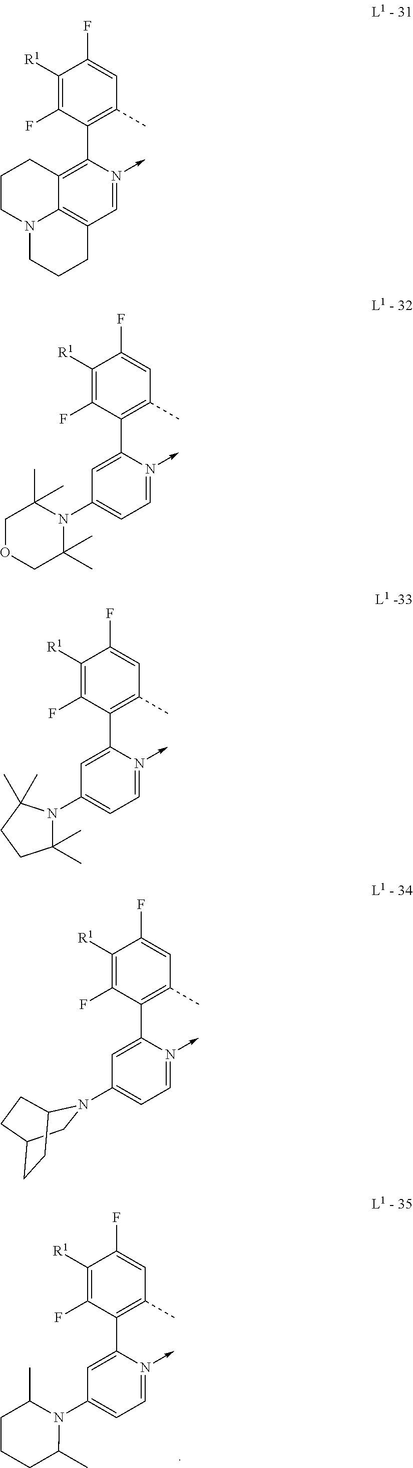

18. A method for emitting light, comprising using the light emitting material in accordance with claim 11 in an emitting layer of an organic light emitting device.

19. A method for emitting light, comprising using the light emitting material in accordance with claim 17 in an emitting layer of an organic light emitting device.

20. An organic light emitting device (OLED) comprising an emissive layer, said emissive layer comprising the light emitting material in accordance with claim 11.
